(19) United States
(12) Patent Application Publication
(10) Pub. No.: US 2007/0145958 A1
(43) Pub. Date: Jun. 28, 2007

(54) Step-up device and step-down device

(76) Inventors: Kenji Miyake, Shiga (JP); Tomokazu Kojima, Osaka (JP); Takahito Kushima, Osaka (JP); Tsutomu Sakakibara, Shiga (JP)

Correspondence Address: MCDERMOTT WILL & EMERY LLP, 600 13TH STREET, N.W., WASHINGTON, DC, 20005-3096, US

(21) Appl. No.: 11/641,876

(22) Filed: Dec. 20, 2006

(30) Foreign Application Priority Data
Dec. 26, 2005 (JP) 2005-371855

(51) Int. Cl. G05F 1/10

(52) U.S. Cl. 323/234

(57) ABSTRACT

A control unit performs the first-third controls. The first control controls a group of switch elements so that a step-up voltage is supplied to a voltage output terminal by a pumping action of a step-up voltage accumulating capacity element by applying the reference power source voltage to the reference power source voltage accumulating capacity element in an inverse direction, after execution of an electric charge accumulating action with the reference power source voltage in the reference power source voltage accumulating capacity element. The second control controls the group of switching elements so as to provide a dead-time period, during which the reference power source and the reference power source voltage accumulating element are disconnected, between a period of the electric charge accumulating action and a period of the pumping action and between the period of pumping action and the period of electric charge accumulating action. The third control achieves such a control in the first and second step-up circuit units alternately and cyclically that the electric charge accumulating action or the pumping action in one of the first and second step-up circuit units is carried out, when the other is in the dead-time period.

### BACKGROUND OF THE INVENTION

1. Field of the Invention

The present invention relates to a step-up device and a step-down device and, more specifically, to a technique for reducing noises of a reference power source in those devices.

2. Description of the Related Art

In a case of a step-up circuit for boosting up twice the reference power source Vci that is lower than a power power source Vcc, the circuit is normally constituted with four switch elements and two capacity elements. This step-up circuit generates a desired output voltage (Vout) by charging/pumping actions based on control signals supplied at a given timing. Fine adjustment of the output voltage (Vout) is achieved through adjusting the reference power source Vci. Such adjustment is carried out because the output of the step-up circuit itself is limited only to integral multiple of the reference power source.

The reference power source is generated from the power power source Vcc within an LSI in many cases. Therefore, it is necessary in the step-up circuit with such characteristic to prevent the two switch elements of inverted logics from being turned ON simultaneously and flowing out a through current, when each switch element is under a switching action. Consequently, in the step-up circuit, regarding the control signals which carry out the charging/pumping actions, a dead-time period where all the switch elements are turned OFF intentionally at the time of the switching action is provided.

FIG. 55 shows the structure of a conventional step-up circuit that generates a voltage (Vout) that is twice the reference power source Vci. A series circuit constituted with a switch element S11 and a switch element S12 is connected between the reference power source Vci and a ground VSS. A series circuit constituted with a switch element S13 and a reference power source voltage accumulating capacity element C1 is connected between the reference power source Vci and the connection point between both switch elements S11, S12. A series circuit constituted with a switch element S14 and a step-up voltage accumulating capacity element C0 is connected between the connection point of the switch element S13 and the capacity element C1, and the ground VSS. The capacity element C0 keeps and outputs the voltage (Vout) that is twice the reference power source Vci. “Vout” indicates a voltage output terminal. The reference power source Vci is a power power source that has no smoothing capacitance.

FIG. 56 is a timing chart showing the action of the step-up circuit. Control signals A, B, C, and D control ON/OFF of the switch elements S11, S12, S13, and S14 respectively. Hatching areas show the dead-time periods (DT). These control signals A, B, C, D are generated through a control unit 60. The control signals A, B, C, and D are supplied to the switch elements S11, S12, S13, and S14 respectively. The switch elements S11, S12, S13, and S14 are constituted with transistors or the like.

The action of the step-up circuit shown in FIG. 55 will be described referring to FIG. 57-FIG. 60. First, as shown in FIG. 57, the switch elements S12 and S13 are turned ON, meanwhile the switch elements S11 and S14 are turned OFF. In this state, the reference voltage of the reference power source Vci is accumulated in the reference power source voltage accumulating capacity element C1. During this period, a load is connected to the reference power source Vci.

Next, as shown in FIG. 58, the switch elements S12 and S13 are turned OFF, while the switch elements S11 and S14 are remained OFF. This state is a preceding dead-time period. During this period, the load is not connected to the reference power source Vci.

Next, as shown in FIG. 59, the switch elements S11 and S14 are turned ON, while the switch elements S12 and S13 are remained OFF. According to this, the reference power source voltage accumulating capacity element C1 and the step-up voltage accumulating capacity element C0 are connected to the circuit, and the electric charges accumulated in the capacity element C1 is supplied to the capacity element C0. During this period, the load is connected to the reference power source Vci.

Next, as shown in FIG. 60, the switch elements S11 and S14 are turned OFF, while the switch elements S12 and S13 are remained OFF. This state is a latter dead-time period. During this period, the load is not connected to the reference power source Vci. Through repeating the actions shown in FIG. 57-FIG. 60, the voltage (Vout) that is twice the reference power source Vci is generated in the capacity element C0.

In the conventional step-up circuit shown in FIG. 55, the operating period and the dead-time period are repeated. That is, the state where there is a load current flown to the reference power source Vci and the state without the load current flown to the reference power source Vci are alternately repeated. Therefore, the reference power source Vci that has no smoothing capacitance boosts up during the dead-time period where the load is not connected, and noises are generated. There is a possibility that the noise thus generated is fed in another circuit so as to cause a bad influence. Step-down circuits also face the same issue.

### SUMMARY OF THE INVENTION

The main object of the present invention therefore is to provide a step-up device and a step-down device, which are capable of reducing noises of clock synchronization in the reference voltage Vci so as to suppress bad influence to other circuits.

In order to achieve the aforementioned object, a step-up device of the present invention comprises
a voltage output terminal,
a step-up voltage accumulating capacity element connected to the voltage output terminal,
a first step-up circuit unit and a second step-up circuit unit connected in parallel to the step-up voltage accumulating capacity element, and
a control unit, wherein:
the first step-up circuit unit and the second step-up circuit unit comprise, respectively,
a reference power source for generating a reference power source voltage,
a reference power source voltage accumulating capacity element, and
a group of switch elements capable of connecting/disconnecting the reference power source and the reference power source voltage accumulating capacity element; wherein
the control unit controls the group of switch elements so that a step-up voltage is supplied to the voltage output terminal by a pumping action carried out in the step-up voltage accumulating capacity element, by applying the reference power source voltage to the reference power power source voltage accumulating capacity element in an inverse direction after an electric charge accumulating action is carried out in the reference power source voltage in the reference power source voltage accumulating capacity element;
the control unit further controls the group of switching elements so that there is a dead-time period during which the reference power power source and the reference power source voltage accumulating element are disconnected, between a period of the electric charge accumulating action and a period of the pumping action, and between the period of the pumping action and the period of the electric charge accumulating action; and
the control unit furthermore performs such a control in the first and second step-up circuit units alternately and cyclically that the period of the electric charge accumulating action or the period of the pumping action is carried out in one of the first and second step-up circuit units, when the other is in the dead-time period.

In this structure, the first step-up circuit unit and the second step-up circuit unit perform the same actions at different timings from each other. That is, in both of the step-up circuit units, switching controls of the group of switch elements are carried out according to the control signals from the control unit. First, the reference power power source is connected to the reference power source voltage accumulating capacity element where the electric charge accumulation action through the reference power source voltage is carried out. Then, by applying the reference power source voltage to the reference power source voltage accumulating capacity element in the inverse direction after the dead-time period for preventing through-current is set up, a pumping action is carried out in the step-up voltage accumulating capacity element so that the step-up voltage is supplied to the voltage output terminal. Further, after a dead-time period for preventing the through-current is set up, an electric charge accumulating action based on the reference power source voltage is carried out again in the reference power source voltage accumulating capacity element. The control unit provides a shift between the timings of the above-described action in the first step-up circuit unit and the same action in the second step-up circuit unit. That is, the electric charge accumulating action of the first step-up circuit unit is carried out in the dead-time period of the second step-up circuit unit, and the pumping action of the first step-up circuit unit is carried out in the next dead-time period of the second step-up circuit unit. Further, the electric charge accumulating action of the second step-up circuit unit is carried out in the dead-time period of the first step-up circuit unit, and the pumping action of the second step-up circuit unit is carried out in the next dead-time period of the first step-up circuit unit.

In short, when one of the step-up circuit units is in the dead-time period for preventing the through-current, the reference power source is connected to the reference power source voltage accumulating capacity element in the other step-up circuit unit in order to carry out the electric charge accumulating action or the pumping action. Thus, the reference power source is maintained in a state with a load. Therefore, even if the reference power source has no smoothing capacitor, generation of the noise in the dead-time period can be prevented.

The above-described structure can be developed as follows when it is constituted with three step-up circuit units. That is, a step-up device of the present invention comprises
a voltage output terminal,
three or more step-up circuit units connected in parallel to the voltage output terminal, and
a control unit, wherein:
the step-up circuit units comprise, respectively,
a reference power source for generating a reference power source voltage,
a reference power source voltage accumulating capacity element, and
a group of switch elements capable of freely connecting/disconnecting the reference power source and the reference power source voltage accumulating capacity element; wherein
the control unit controls the group of switch elements so that a step-up voltage is supplied to the voltage output terminal through carrying out a pumping action in the step-up voltage accumulating capacity element, by applying the reference power source voltage to the reference power source voltage accumulating capacity element in an inverse direction after an electric charge accumulating action is carried out based on the reference power source voltage in the reference power source voltage accumulating capacity element;
the control unit further controls the group of switching elements so that a dead-time period is present during which the reference power source and the reference power source voltage accumulating element are disconnected, between a period of the electric charge accumulating action and a period of the pumping action, and between the period of the pumping action and the period of the electric charge accumulating action; and
the control unit furthermore executes, sequentially and cyclically in the three or more step-down circuit units, the control for performing the electric charge accumulating action or the pumping action in other units in the dead-time period in one of the three or more step-down circuit units. In this case, the step-up voltage accumulating capacity element is not necessarily essential.

In this structure, the functions of each step-up circuit unit are the same as those described above. The control unit provides a shift between the timings of actions carried out by a plurality of step-up circuit units described above. That is, in the dead-time period of the third step-up circuit unit, the first step-up circuit unit performs the electric charge accumulating action and the second step-un circuit unit performs the pumping action. In the next dead-time period of the third step-up circuit unit, the first step-up circuit unit performs the pumping action and the second step-up circuit unit performs the electric charge accumulating action. In the dead-time period of the second step-up circuit unit, the first step-up circuit unit performs the electric charge accumulating action and the second step-up circuit unit performs the pumping action. In the next dead-time period of the second step-up circuit unit, the first step-up circuit unit performs the pumping action and the second step-up circuit unit performs the electric charge accumulating action. In the dead-time period of the first step-up circuit unit, the second step-up circuit unit performs electric charge accumulating action and the third step-up circuit unit performs the pumping action. In the next dead-time period of the first step-up circuit unit, the second step-up circuit unit performs the pumping action and the third step-up circuit unit performs electric charge accumulating action.

In short, when one of the step-up circuit units is in the dead-time period for preventing the through-current, the reference power source is connected to the reference power source voltage accumulating capacity element in other step-up circuit units for carrying out the electric charge accumulating action or the pumping action. Thus, the reference power source is maintained in a state with a load. Therefore, even if the reference power source has no smoothing capacitor, generation of the noise in the dead-time period can be prevented.

In the structure consisting of only two step-up circuit units, during the dead-time period in one of the step-up circuit units, the period for carrying out the electric charge accumulating action and the period for carrying out the pumping action are divided in the other of the step-up circuit units. Thus, in the structure with only two step-up circuit units, there is a period where only the electric charge accumulating action is carried out without performing a pumping action. This structure therefore requires a step-up voltage accumulating capacity element for avoiding pressure drop in the voltage output terminal during such period. In the above-described structure having three or more step-up circuit units, however, the pumping action is always carried out in all of the periods, and the electric charges are supplied to the voltage output terminal from at least one of the step-up circuit units. Thus, the step-up voltage accumulating capacity element is not necessarily essential, and it can be omitted. In a structure having a step-up voltage accumulating capacity element, however, the electric charges are always supplied to the capacity element from at least one of the step-up circuit units by the step-up pumping action. Therefore, an effect of reducing the step-up voltage ripples and an effect of improving the current ability can be achieved.

There is also such a structure that a load current source such as a load resistance is replaced instead of connecting a plurality of step-up circuit units in parallel as described above. Such structure is developed as follows.

A step-up device of the present invention comprise
a voltage output terminal,
a step-up voltage accumulating capacity element connected to the voltage output terminal,
a step-up circuit unit connected to the step-up voltage accumulating capacity element, and
a control unit, wherein:
the step-up circuit unit comprises
a reference power source for generating a reference power source voltage,
a reference power source voltage accumulating capacity element,
a load current source,
a first group of switch elements capable of freely connecting/disconnecting the reference power source and the reference power source voltage accumulating capacity element, and
a second switch element capable of freely connecting/disconnecting the reference power source and the load current source; wherein
the control unit controls the first group of switch elements so that a step-up voltage is supplied to the voltage output terminal by a pumping action carried out in the step-up voltage accumulating capacity element, by applying the reference power source voltage to the reference power source voltage accumulating capacity element in an inverse direction after an electric charge accumulating action is carried out based on the reference power source voltage in the reference power source voltage accumulating capacity element;
the control unit further controls the first group of switching elements so that a dead-time period is present during which the reference power source and the reference power source voltage accumulating element are disconnected, between a period of the electric charge accumulating action and a period of the pumping action and between the period of the pumping action and the period of the electric charge accumulating action; and
the control unit furthermore controls the second switch element so that the reference power source and the load current source are selectively connected in the dead-time period.

In this structure, the reference power source can be maintained in a state with a load by connecting the load current source to the reference power source based on the switching control by the control unit in the dead-time period for preventing the through-current. Therefore, even if the reference power source has no smoothing capacitor, generation of the noise in the dead-time period can be prevented.

The technique of the step-up device described above can be developed into a step-down device in the following manner. A step-down device of the present invention comprises
a voltage output terminal,
three or more step-down circuit units connected in parallel to the step-up voltage output terminal, and
a control unit, wherein:
the step-down circuit units comprise respectively,
a reference power source for generating a reference power source voltage,
a reference power source voltage accumulating capacity element, and
a group of switch elements capable of freely connecting/disconnecting the reference power source and the reference power source voltage accumulating capacity element; wherein
the control unit controls the group of switch elements such that a step-down voltage is supplied to the voltage output terminal by a pumping action performed in the reference power source voltage accumulating capacity element, by applying the reference power source voltage to the reference power source voltage accumulating capacity element in a same direction after an electric charge accumulating action based on the reference power source voltage is carried out in the reference power source voltage accumulating capacity element;
the control unit further controls the group of switching elements so that a dead-time period is present during which the reference power source and the reference power source voltage accumulating element are disconnected, between a period of the electric charge accumulating action and a period of the pumping action, and between the period of the pumping action and the period of the electric charge accumulating action; and
the control unit furthermore executes, sequentially and cyclically in the three or more step-down circuit units, the control for performing the electric charge accumulating action or the pumping action in other units in the dead-time period in one of the three or more step-down circuit units. In this case, the step-down voltage accumulating capacity element is not necessarily essential.

In this structure, plurality of the circuit units perform the same actions at different timings from each other. That is, in any of the step-up circuit units, switching controls of the group of switch elements are carried out based on the control signals form the control unit. First, the reference power source is connected to the reference power source voltage accumulating capacity element so that the electric charge accumulation action based on the reference power source voltage is carried out. Then, the dead-time period for preventing through- current is provided, and the reference power source voltage is applied to the reference power source voltage accumulating capacity element in the same direction. By doing so, a step-down pumping action is carried out to supply the step-down voltage to the voltage output terminal. Further, after a dead-time period for preventing the through current, an electric charge accumulating action based on the reference power source voltage is carried out again in the reference power source voltage accumulating capacity element. The control unit performs the electric charge accumulating action in the first step-down circuit unit and performs the pumping action in the second step-down circuit unit, in the dead-time period of the third step-down circuit unit. In the next dead-time period of the third step-down circuit unit, the first step-down circuit unit performs the pumping action and the second step-down circuit unit performs the electric charge accumulating action. In the dead-time period of the second step-down circuit unit, the first step-down circuit unit performs the electric charge accumulating action and the second step-down circuit unit performs the step-down pumping action. Additionally, in the next dead-time period of the second step-down circuit unit, the first step-down circuit unit performs the step-down pumping action and the third step-down circuit unit performs the electric charge accumulating action. In the dead-time period of the first step-down circuit unit, the second step-down circuit unit performs electric charge accumulating action and the third step-down circuit unit performs the step-down pumping action. In the next dead-time period of the first step-down circuit unit, the second step-down circuit unit performs the step-down pumping action and the third step-down circuit unit performs electric charge accumulating action.

In short, when one of the step-down circuit units is in the dead-time period for preventing the through-current, the reference power source is connected to the reference power source voltage accumulating capacity element in order to carry out the electric charge accumulating action or the step-down pumping action in other step-down circuit units. Thus, the reference power source is maintained in a state with a load. Therefore, even if the reference power source has no smoothing capacitor, generation of the noise in the dead-time period can be prevented.

Furthermore, as this structure comprises three or more step-down circuit units, there is always the step-down pumping action to the voltage output terminal in all of the periods, and thereby it is possible to maintain the state where the electric charges are always supplied to the voltage output terminal from at least one of the step-down circuit units. Therefore, the step-down voltage accumulating capacity element is not necessarily essential, and the step-down voltage accumulating capacity element can be omitted. In a structure having a step-down voltage accumulating capacity element, however, the electric charges are always supplied to the capacity element from at least one of the step-down circuit units based on the step-down pumping action. Therefore, in the structure having the step-down voltage accumulating capacity element, an effect of reducing the step-down voltage ripples and an effect of improving the current capacity can be obtained.

The technique of the step-up device described above can be developed into a step-up device where two output voltages is generated from the same reference power source. It is possible to be developed in the following manner.

A step-up device of the present invention comprises
a first voltage output terminal,
a second voltage output terminal,
a first step-up voltage accumulating capacity element connected to the first voltage output terminal,
a first step-up circuit unit connected to the first step-up Voltage accumulating capacity element,
a second step-up voltage accumulating capacity element connected to the second voltage output terminal,
a second step-up circuit unit connected to the second step-up voltage accumulating capacity element, and
a control unit, wherein:
the first step-up circuit unit and the second step-up circuit unit comprise, respectively,
a reference power source for generating a reference power source voltage,
a reference power source voltage accumulating capacity element, and
a group of switch elements capable of freely connecting/disconnecting the reference power source and the reference power source voltage accumulating capacity element;
the control unit controls the group of switch elements so that a step-up voltage is supplied to the first voltage output terminal and the second voltage output terminal by pumping actions carried out in the first step-up voltage accumulating capacity element and the second step-up voltage accumulating capacity element, through carrying out an electric charge accumulating action with the reference power source voltage in the reference power source voltage accumulating capacity element after applying the reference power source voltage to the reference power source voltage accumulating capacity element in an inverse direction;
further, the control unit controls the group of switching elements to provide a dead-time period, during which the reference power source and the reference power source voltage accumulating element are disconnected, between a period of the electric charge accumulating action and a period of the pumping action and between the period of the pumping action and the period of the electric charge accumulating action; and
furthermore, the control unit performs such a control alternately and cyclically in the first and second step-up circuit units that the period of the electric charge accumulating action or the period of the pumping action is carried out in one of the first and second step-up circuit units when the other is in the dead-time period.

In this structure, the first step-up circuit unit and the second step-up circuit unit perform the same actions at different timings with each other. That is, in both of the step-up circuit units, switching controls of the group of switch elements are carried out according to the control signals form the control unit. First, the reference power source is connected to the reference power source voltage accumulating capacity element where the electric charge accumulation action by the reference power source voltage is carried out. Then, after the dead-time period for preventing through-current is provided, the reference power source voltage is applied to the reference power source voltage accumulating capacity element in the inverse direction. By doing so, a pumping action is carried out in the step-up voltage accumulating capacity element so as to supply the step-up voltage to the first voltage output terminal and the second voltage output terminal. Further, after interspacing a dead-time period for preventing the through-current, an electric charge accumulating action is carried out again through the reference power source voltage in the reference power source voltage accumulating capacity element. The control unit provides a shift between the timings of the above-described action of the first step-up circuit unit and the same action of the second step-up circuit unit. That is, the electric charge accumulating action of the first step-up circuit unit is carried out in the dead-time period of the second step-up circuit unit, and the pumping action of the first step-up circuit unit is carried out in the next dead-time period of the second step-up circuit unit. Further, the electric charge accumulating action of the second step-up circuit unit is carried out in the dead-time period of the first step-up circuit unit, and the pumping action of the second step-up circuit unit is carried out in the next dead-time period of the first step-up circuit unit.

In short, when one of the step-up circuit units is in the dead-time period for preventing the through-current, the reference power source is connected to the reference power source voltage accumulating capacity element in the other step-up circuit unit for carrying out the electric charge accumulating action or the pumping action. Thus, the reference power source is maintained in a state under a load. Therefore, even if the reference power source has no smoothing capacitor, generation of the noise in the dead-time period can be prevented.

According to the step-up device and the step-down device of the present invention, the reference power source is connected to the reference power source voltage accumulating capacity element in the other step-up circuit unit or in the other step-down circuit unit for carrying out the electric charge accumulating action or the pumping action during the dead-time period for preventing the through-current. Thus, the reference power source is maintained in a state under a load. Therefore, even if the reference power source has no smoothing capacitor, generation of the noise in the dead-time period can be prevented. As a result, bad influences to other circuits can be suppressed so as to achieve a stable operation.

The step-up device and the step-down device of the present invention have the effects such as reducing the noise of the reference power source of the step-up device that uses the output voltage of the reference power source generator with no smoothing capacitor as the reference power source, and decreasing the bad influence of the noise to other circuits. Thus, the present invention is effective for a power source circuit and the like with a built-in step-up device or step-down device.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a circuit block diagram showing the structure of a step-up device according to a first embodiment of the present invention;

FIG. 2 is a signal waveform chart showing the actions of the step-up device according to the first embodiment of the present invention;

FIG. 3 is a first illustration for describing the action of the step-up device according to the first embodiment of the present invention;

FIG. 4 is a second illustration for describing the action of the step-up device according to the first embodiment of the present invention;

FIG. 5 is a third illustration for describing the action of the step-up device according to the first embodiment of the present invention;

FIG. 6 is a fourth illustration for describing the action of the step-up device according to the first embodiment of the present invention;

FIG. 7 is a fifth illustration for describing the action of the step-up device according to the first embodiment of the present invention;

FIG. 8 is a sixth illustration for describing the action of the step-up device according to the first embodiment of the present invention;

FIG. 9 is a seventh illustration for describing the action of the step-up device according to the first embodiment of the present invention;

FIG. 10 is an eighth illustration for describing the action of the step-up device according to the first embodiment of the present invention;

FIG. 11 is a circuit block diagram showing the structure of a step-up device according to a second embodiment of the present invention;

FIG. 12 is a signal waveform chart for showing the actions of the step-up device according to the second embodiment of the present invention;

FIG. 13 is a first illustration for describing the action of the step-up device according to the second embodiment of the present invention;

FIG. 14 is a second illustration for describing the action of the step-up device according to the second embodiment of the present invention;

FIG. 15 is a third illustration for describing the action of the step-up device according to the second embodiment of the present invention;

FIG. 16 is a fourth illustration for describing the action of the step-up device according to the second embodiment of the present invention;

FIG. 17 is a fifth illustration for describing the action of the step-up device according to the second embodiment of the present invention;

FIG. 18 is a sixth illustration for describing the action of the step-up device according to the second embodiment of the present invention;

FIG. 19 is a seventh illustration for describing the action of the step-up device according to the second embodiment of the present invention;

FIG. 20 is an eighth illustration for describing the action of the step-up device according to the second embodiment of the present invention;

FIG. 21 is a ninth illustration for describing the action of the step-up device according to the second embodiment of the present invention;

FIG. 22 is a tenth illustration for describing the action of the step-up device according to the second embodiment of the present invention;

FIG. 23 is an eleventh illustration for describing the action of the step-up device according to the second embodiment of the present invention;

FIG. 24 is a twelfth illustration for describing the action of the step-up device according to the second embodiment of the present invention;

FIG. 25 is a circuit block diagram showing the structure of a step-down device according to a third embodiment of the present invention;

FIG. 26 is a signal waveform chart for showing the actions of the step-down device according to the third embodiment of the present invention;

FIG. 27 is a first illustration for describing the action of the step-down device according to the third embodiment of the present invention;

FIG. 28 is a second illustration for describing the action of the step-down device according to the third embodiment of the present invention;

FIG. 29 is a third illustration for describing the action of the step-down device according to the third embodiment of the present invention;

FIG. 30 is a fourth illustration for describing the action of the step-down device according to the third embodiment of the present invention;

FIG. 31 is a fifth illustration for describing the action of the step-down device according to the third embodiment of the present invention;

FIG. 32 is a sixth illustration for describing the action of the step-down device according to the third embodiment of the present invention;

FIG. 33 is a seventh illustration for describing the action of the step-down device according to the third embodiment of the present invention;

FIG. 34 is an eighth illustration for describing the action of the step-down device according to the third embodiment of the present invention;

FIG. 35 is a ninth illustration for describing the action of the step-down device according to the third embodiment of the present invention;

FIG. 36 is a tenth illustration for describing the action of the step-down device according to the third embodiment of the present invention;

FIG. 37 is an eleventh illustration for describing the action of the step-down device according to the third embodiment of the present invention;

FIG. 38 is a twelfth illustration for describing the action of the step-down device according to the third embodiment of the present invention;

FIG. 39 is a circuit block diagram showing the structure of a step-up device according to a fourth embodiment of the present invention;

FIG. 40 is a signal waveform chart showing the actions of the step-up device according to the fourth embodiment of the present invention;

FIG. 41 is a first illustration for describing the action of the step-up device according to the fourth embodiment of the present invention;

FIG. 42 is a second illustration for describing the action of the step-up device according to the fourth embodiment of the present invention;

FIG. 43 is a third illustration for describing the action of the step-up device according to the fourth embodiment of the present invention;

FIG. 44 is a fourth illustration for describing the action of the step-up device according to the fourth embodiment of the present invention;

FIG. 45 is a circuit block diagram showing the structure of a step-up device according to a fifth embodiment of the present invention;

FIG. 46 is a signal waveform chart showing the actions of the step-up device according to the fifth embodiment of the present invention;

FIG. 47 is a first illustration for describing the action of the step-up device according to the fifth embodiment of the present invention;

FIG. 48 is a second illustration for describing the action of the step-up device according to the fifth embodiment of the present invention;

FIG. 49 is a third illustration for describing the action of the step-up device according to the fifth embodiment of the present invention;

FIG. 50 is a fourth illustration for describing the action of the step-up device according to the fifth embodiment of the present invention;

FIG. 51 is a fifth illustration for describing the action of the step-up device according to the fifth embodiment of the present invention;

FIG. 52 is a sixth illustration for describing the action of the step-up device according to the fifth embodiment of the present invention;

FIG. 53 is a seventh illustration for describing the action of the step-up device according to the fifth embodiment of the present invention;

FIG. 54 is an eighth illustration for describing the action of the step-up device according to the fifth embodiment of the present invention;

FIG. 55 is a circuit block diagram showing the structure of a step-up device according to a related art;

FIG. 56 is a signal waveform chart showing the actions of the step-up device according to the related art;

FIG. 57 is a first illustration for describing the action of the step-up device according to the related art;

FIG. 58 is a second illustration for describing the action of the step-up device according to the related art;

FIG. 59 is a third illustration for describing the action of the step-up device according to the related art; and

FIG. 60 is a fourth illustration for describing the action of the step-up device according to the related art.

### DETAILED DESCRIPTION OF THE INVENTION

Hereinafter, embodiments of a step-up device and a step-down device according to the present invention will be described in detail referring to the accompanying drawings.

### First Embodiment

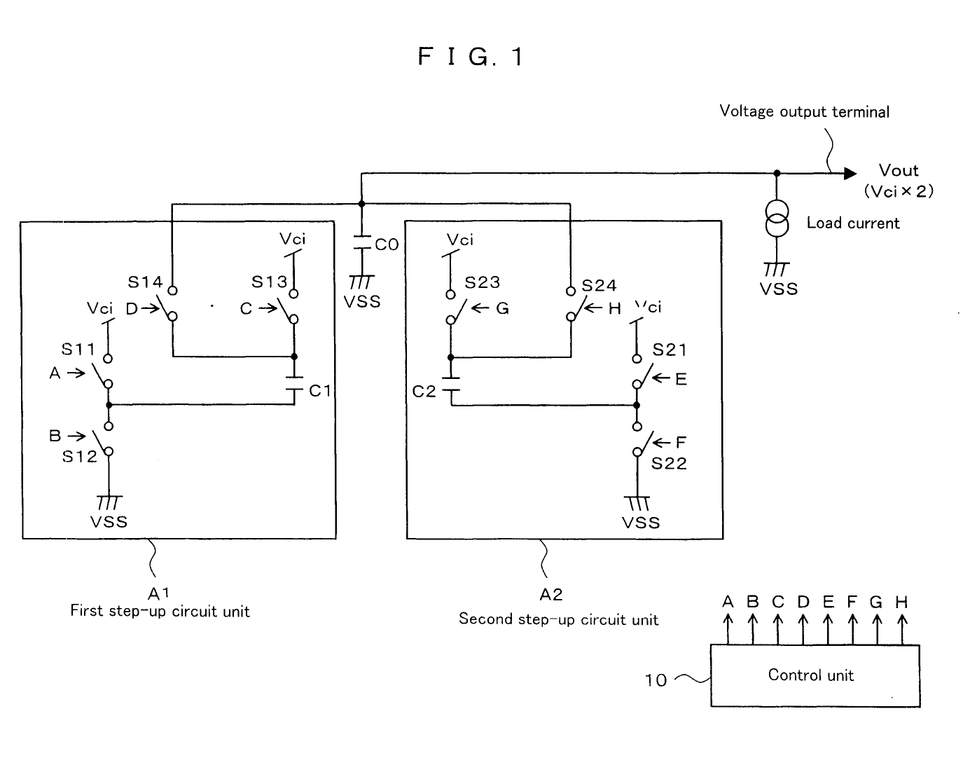

FIG. 1 is a circuit block diagram showing the structure of the step-up device according to a first embodiment of the present invention. As shown in FIG. 1, a step-up voltage accumulating capacity element C0 is connected to a voltage output terminal Vout. A first step-up circuit unit A1 and a second step-up circuit unit A2 are connected in parallel to the capacity element C0. The capacity element C0 keeps and outputs a voltage (Vout) that is twice the reference power source Vci.

In the first step-up circuit unit A1, switch elements S11 and S12 are connected in series between the reference power source Vci and a ground VSS. A reference power source voltage accumulating capacity element C1 and a switch element S13 are connected in series between the connection point of both switch elements S11, S12 and the reference power source Vci. A switch element S14 and the capacity element C0 are connected in series between the connection point of the switch element 13 and the capacity element C1, and the ground VSS. The switch elements S11, S12, S13, S14 and the capacity element C1 constitute the first step-up circuit unit A1.

In the second step-up circuit unit A2, switch elements S21 and S22 are connected in series between a reference power source Vci and a ground VSS. A reference power source voltage accumulating capacity element C2 and a switch element S23 are connected in series between the connection point of both switch elements S21, S22 and the reference power source Vci. A switch element S24 and the capacity element C0 are connected in series between the connection point of the switch element 23 and the capacity element C2, and the ground VSS. The switch elements S21, S22, S23, S24 and the capacity element C2 constitute the second step-up circuit unit A2.

One end of the capacity element C0 is connected to the ground VSS, and the other end thereof is connected to the switch elements S14 and S24. As a result, the voltage (Vout) that is twice the reference power source Vci is outputted to this section (connection point between the other end of the capacity element C0 and the switch elements S14, S24).

Reference numeral 10 is a control unit. The control unit 10 generates control signals A, B, C, D for controlling ON/OFF of the switch elements S11, S12, S13, S14 in the first step-up circuit unit A1, and control signals E, F, G, H for controlling the switch elements S11, S12, S13, S14 in the second step-up circuit unit A2. The control unit 10 performs a control to carry out an electric charge accumulation action or pumping action in one of the first or second step-up circuit A1 or A2, when the other step-up circuit is in a dead-time period. This control is carried out alternately and cyclically between both step-up circuits A1 and A2 in the control unit 10. Each of the switch elements is constituted with a transistor or the like. The reference power source Vci is a power supply having no smoothing capacitance.

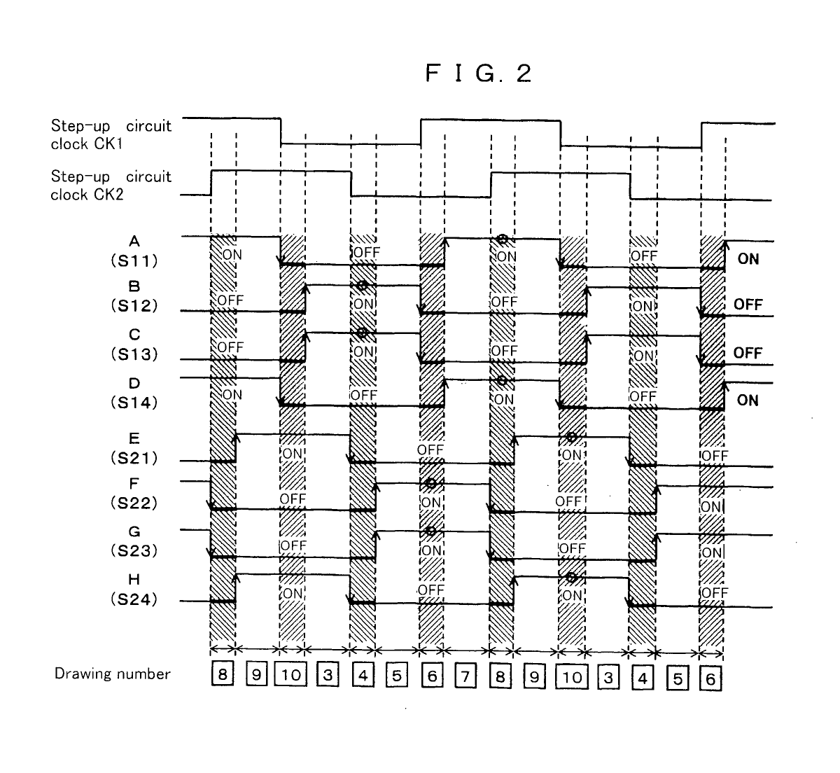

FIG. 2 is a timing chart showing the actions of the step-up device according to this embodiment. The control signals A, B, C, and D are generated according to a first clock CK1 for the step-up circuit. The control signals E, F, G, and H are generated according to a second clock CK2 for the step-up circuit. In FIG. 2, hatching areas are dead-time periods (DT).

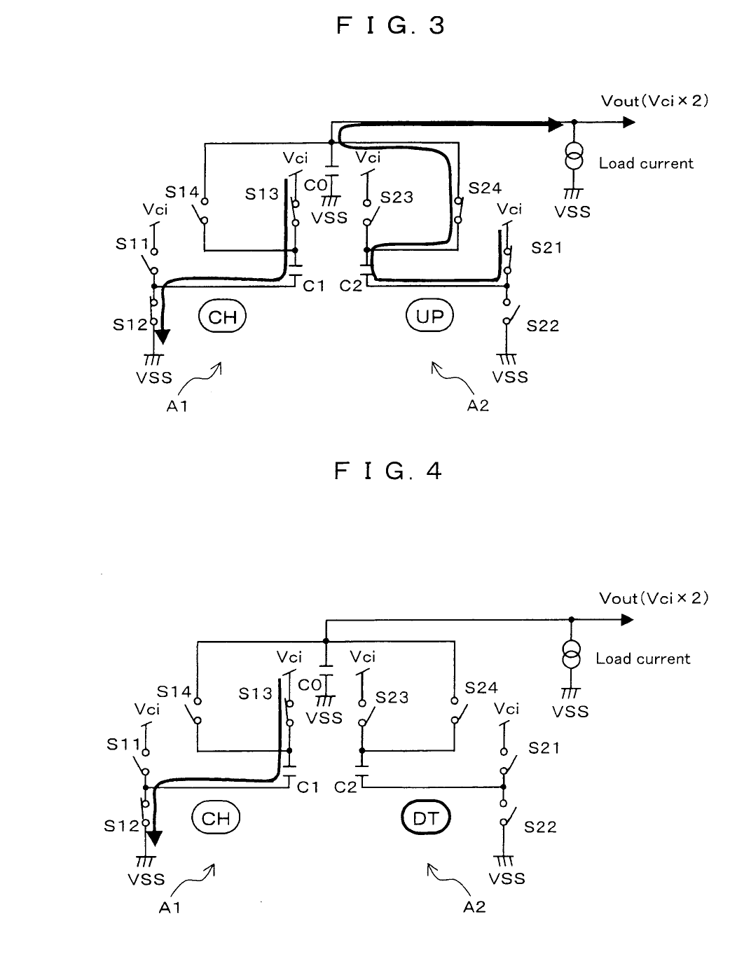

Next, the action of the step-up device according to this embodiment, which is constituted in the above-described manner, will be described referring to FIG. 3-FIG. 10. First, as shown in FIG. 3, the switch elements S12, S13 of the first step-up circuit unit A1 and the switch elements S21, S24 of the second step-up circuit unit A2 are turned ON, and the switch elements S11, S14 and the switch elements S22, S23 are turned OFF. In this period, the capacity element C1 of the first step-up circuit unit A1 is in the state (CH) of accumulating the reference voltage of the reference power source Vci, and the capacity element C2 of the second step-up circuit unit A2 is in the state (UP) of supplying the accumulated electric charge to the capacity element C0 by a pumping action. In this period, loads at two sections are connected to the reference power source Vci. This state in this period is expressed as [A1, A2]=[CH, UP].

Next, as shown in FIG. 4, the switch elements S21 and S24 in the second step-up circuit unit A2 are turned OFF from the state shown in FIG. 3. In this period, the capacity element C1 in the first step-up circuit unit A1 is in the state (CH) of accumulating the reference voltage of the reference power source Vci, and the second step-up circuit unit A2 is in the dead-time period (DT). The first step-up circuit unit A1 remains in the operating state. In this period, the load at one section is connected to the reference power source Vci. The state in this period is expressed as [A1, A2]=[CH, DT].

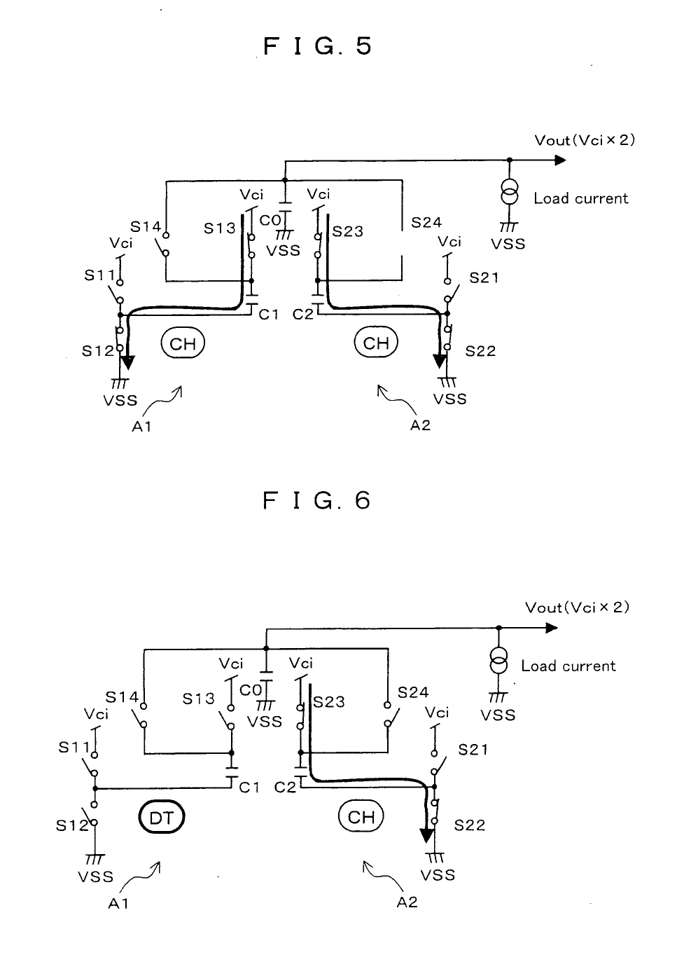

Next, as shown in FIG. 5, the switch elements S22 and S23 in the second step-up circuit unit A2 are turned ON from the state shown in FIG. 4. In this period, the capacity element C1 in the first step-up circuit unit A1 is in the state (CH) of accumulating the reference voltage of the reference power source Vci, and the capacity element C2 in the second step-up circuit unit A2 also is in the state (CH) for accumulating the reference voltage of the reference power source Vci. In this period, the loads at two sections are connected to the reference power source Vci. The state in this period is expressed as [A1, A2]=[CH, CH].

Next, as shown in FIG. 6, the switch elements S12 and S13 in the first step-up circuit unit A1 are turned OFF from the state shown in FIG. 5. In this period, the capacity element C2 in the second step-up circuit unit A2 is in the state (CH) of accumulating the reference voltage of the reference power source Vci, and the first step-up circuit unit A1 is in the dead-time period (DT). The second step-up circuit unit A2 remains in the operating state in this period, so that the load at one section is connected to the reference power source Vci. The state in this period is expressed as [A1, A2]=[DT, CH].

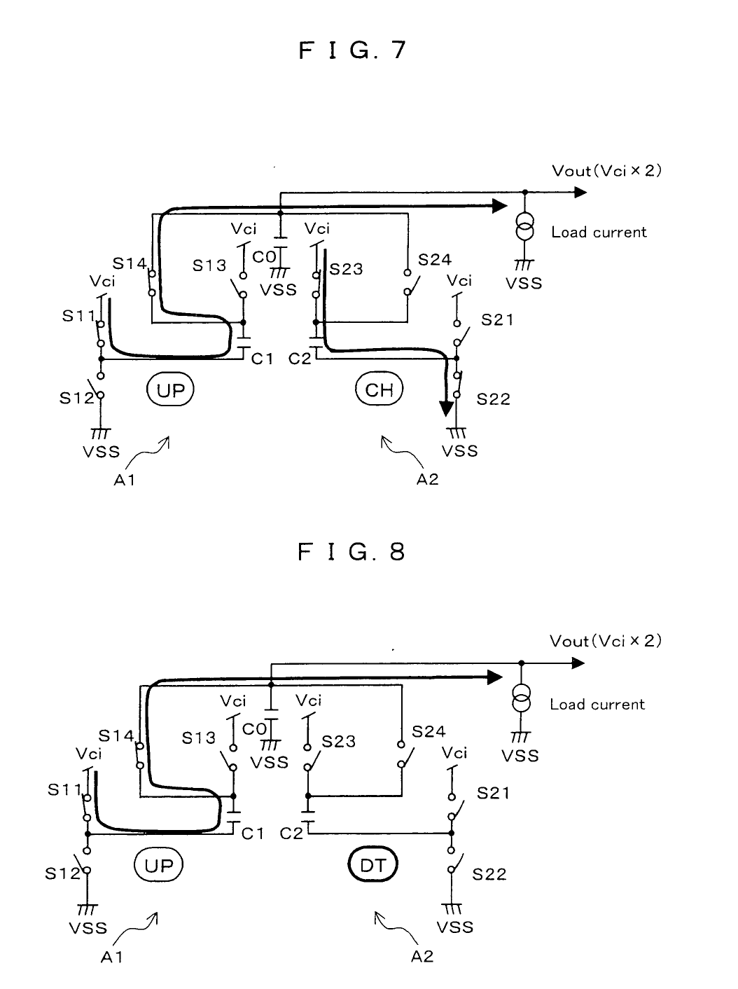

Next, as shown in FIG. 7, the switch elements S11 and S14 in the first step-up circuit unit A1 are turned ON from the state shown in FIG. 6 so as to apply the reference voltage of the reference power source Vci to the reference power source voltage accumulating capacity element C1 in the inverse direction. During this period, the capacity element C2 of the second step-up circuit unit A2 is in the state (CH) of accumulating the reference voltage of the reference power source Vci, and the capacity element C1 of the first step-up circuit unit A1 is in the state (UP) of supplying the accumulated electric charge to the capacity element C0 by a pumping action. During this period, the loads at two sections are connected to the reference power source Vci. This state in this period is expressed as [A1, A2]=[UP, CH].

Next, as shown in FIG. 8, the switch elements S22 and S23 in the second step-up circuit unit A2 are turned OFF from the state shown in FIG. 7. In this period, the capacity element C1 of the first step-up circuit unit A1 is in the state (UP) of supplying the accumulated electric charge to the capacity element C0 by a pumping action, and the second step-up circuit unit A2 is in the dead-time period (DT). The first step-up circuit unit A1 remains in the operating state in this period, so that the load at one section is connected to the reference power source Vci. The state in this period is expressed as [A1, A2]=[UP, DT].

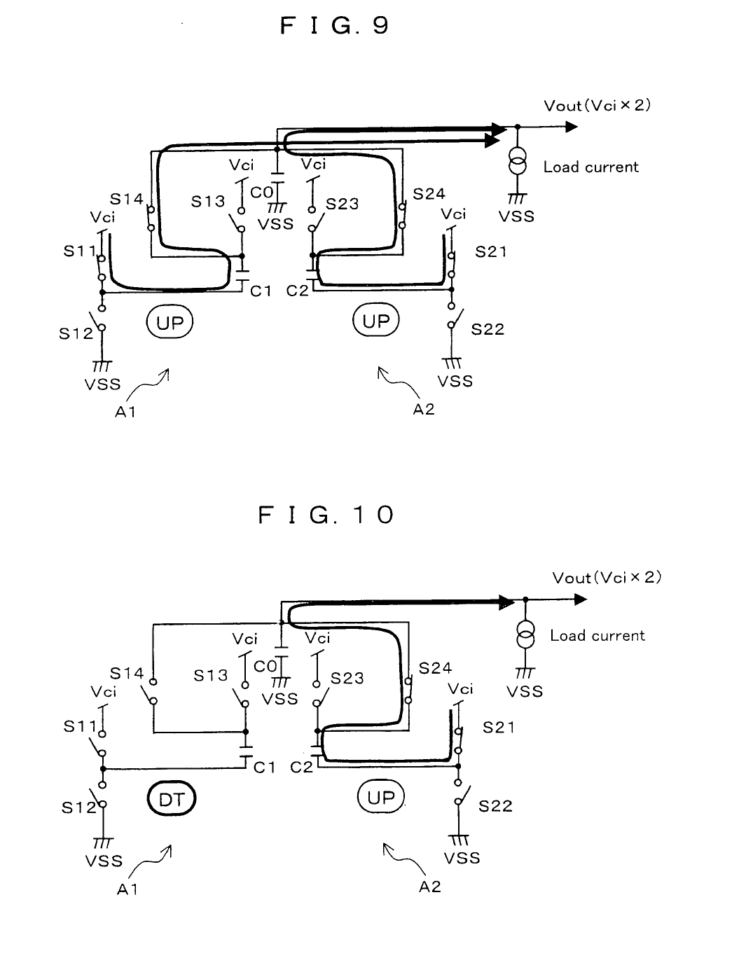

Next, as shown in FIG. 9, the switch elements S21 and S24 in the second step-up circuit unit A2 are turned ON from the state shown in FIG. 8 so as to apply the reference voltage of the reference power source Vci to the reference power source voltage accumulating capacity element C2 in the inverse direction. During this period, the capacity element C1 of the first step-up circuit unit A1 is in the state (UP) of supplying the accumulated electric charge to the capacity element C0 by a pumping action, and the capacity element C2 of the second step-up circuit unit A2 is in the state (UP) of supplying the accumulated electric charge to the capacity element C0 by a pumping action as well. During this period, the loads at two sections are connected to the reference power source Vci. This state in this period is expressed as [A1, A2]=[UP, UP].

Next, as shown in FIG. 10, the switch elements S11 and S14 in the first step-up circuit unit A1 are turned OFF from the state shown in FIG. 9. In this period, the capacity element C2 of the second step-up circuit unit A2 is in the state (UP) of supplying the accumulated electric charge to the capacity element C0 by a pumping action, and the first step-up circuit unit A1 is in the dead-time period (DT). The second step-up circuit unit A2 remains in the operating state in this period, so that the load at one section is connected to the reference power source Vci. The state in this period is expressed as [A1, A2]=[DT, UP].

Through repeating the actions shown in FIG. 3-FIG. 10, the voltage (Vout) that is twice the reference power source Vci is generated in the step-up voltage accumulating capacity element C0.

In the period in FIG. 2, that corresponds to the state shown in FIG. 4, all of the four switch elements S21, S22, S23, and S24 in the second step-up circuit unit A2 are turned OFF, so that the second step-up circuit unit A2 is in the dead-time period (DT). At this time, the switch elements S12 and S13 are ON in the first step-up circuit unit A1, so that the state (CH) of accumulating the reference voltage of the reference power source Vci can be secured therein.

Further, in the period in FIG. 2, that corresponds to the state shown in FIG. 6, all of the four switch elements S11, S12, S13, and S14 in the first step-up circuit unit A1 are turned OFF, so that the first step-up circuit unit A1 is in the dead-time period (DT). At this time, the switch elements S22 and S23 are ON in the second step-up circuit unit A2, so that the state (CH) of accumulating the reference voltage of the reference power source Vci can be secured therein.

In the period in FIG. 2, that corresponds to the state shown in FIG. 8, all of the four switch elements S21, S22, S23, and S24 in the second step-up circuit unit A2 are turned OFF, so that the second step-up circuit unit A2 is in the dead-time period (DT). At this time, the switch elements S11 and S14 are ON in the first step-up circuit unit A1, so that the state (UP) of supplying the accumulated electric charge to the capacity element C0 can be secured therein.

In the period in FIG. 2, that corresponds to the state shown in FIG. 10, all of the four switch elements S11, S12, S13, and S14 in the first step-up circuit unit A1 are turned OFF, so that the first step-up circuit unit A1 is in the dead-time period (DT). At this time, the switch elements S21 and S24 are ON in the second step-up circuit unit A2, so that the state (UP) of supplying the accumulated electric charge to the capacity element C0 can be secured therein.

The states described above can be summarized as follows.
FIG. 3−[A1, A2]=[CH, UP]
FIG. 4−[A1, A2]=[CH, DT]
FIG. 5−[A1, A2]=[CH, CH]
FIG. 6−[A1, A2]=[DT, CH]
FIG. 7−[A1, A2]=[UP, CH]
FIG. 8−[A1, A2]=[UP, DT]
FIG. 9−[A1, A2]=[UP, UP]
FIG. 10−[A1, A2]=[DT, UP]

Looking at the record of the actions in the first step-up circuit unit A1, it is a cyclic action of CH→CH→CH→DT→UP→UP→UP→DT. Looking at the record of the actions in the second step-up circuit unit A2, it is a cyclic action of UP→DT→CH→CH→CH→DT→UP→UP. The actions of both step-up circuit units A1 and A2 are the cyclic actions of the same pattern even though the timings thereof are different.

When the second step-up circuit unit A2 is in the dead-time period (DT) (in the state of FIG. 4 or FIG. 8), the first step-up circuit unit A1 is in the state (CH) of accumulating the reference voltage of the reference power source Vci or in the state (UP) of supplying the accumulated electric charge to the capacity element C0 by a pumping action.

Further, when the first step-up circuit unit A1 is in the dead-time period (DT) (in the state of FIG. 6 or FIG. 10), the second step-up circuit unit A2 is in the state (CH) of accumulating the reference voltage of the reference power source Vci or in the state (UP) of supplying the accumulated electric charge to the capacity element C0 by a pumping action.

In short, the following rules are maintained.

[A1, A2]=[with load, DT]

[A1, A2]=[DT, with load]

That is, even if one of the step-up circuit units is in the dead-time period (DT), the other step-up circuit unit always keeps the state where a load is connected to the reference power source Vci that has no smoothing capacitance. The [DT, no load] state in the case of the conventional technique is thereby solved, so that noises generated due to the [DT, no load] state can be suppressed.

In short, according to the embodiment, as it is in the state where the load is always imposed upon the reference power source Vci, it enables the boost-up action and noise reduction in the reference power source Vci.

### Second Embodiment

The first embodiment has been described with respect to the step-up device in which two step-up circuit units are connected in parallel. However, the same effects as those described above can be also achieved in the case of a step-up device in which three or more step-up circuit units are connected. It is a second embodiment of the present invention to have achieved that apparatus. Hereinafter, the step-up device according to the second embodiment will be described.

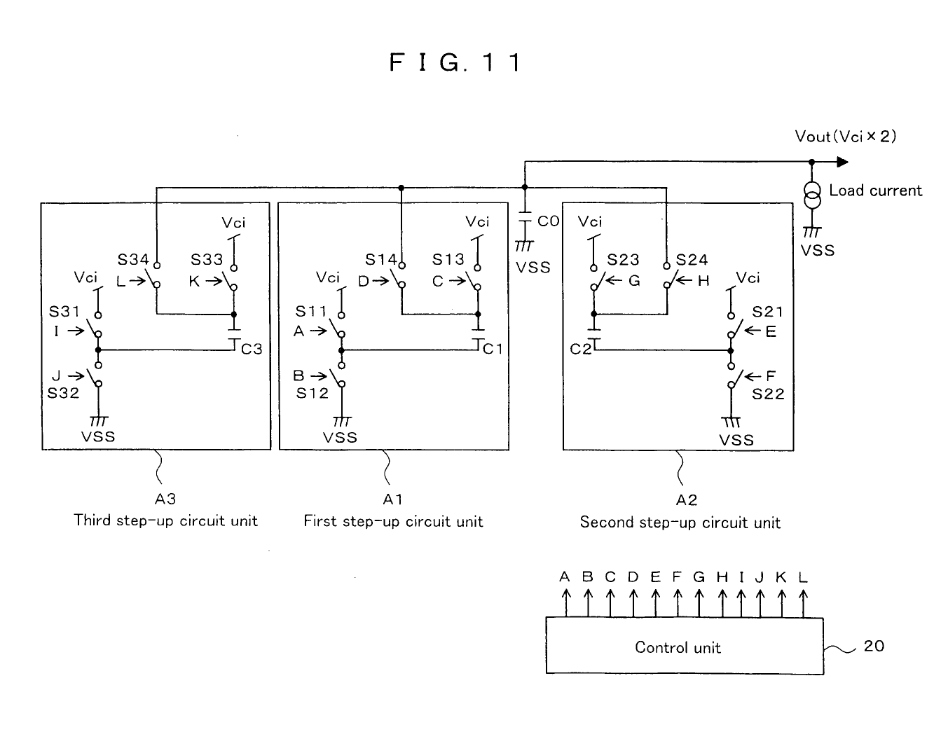

FIG. 11 is a circuit block diagram showing the structure of the step-up device according to the second embodiment. A step-up voltage accumulating capacity element C0 is connected to a voltage output terminal Vout. A first step-up circuit unit A1, a second step-up circuit unit A2, and a third step-up circuit unit A3 are connected in parallel to the capacity element C0. The capacity element C0 keeps and outputs the voltage (Vout) that is twice the reference power source Vci. The first and the second step-up circuit unit A1 and A2 comprise the same structures as those of the first and second step-up circuit units A1 and A2.

In the third step-up circuit unit A3, switch elements S31 and S32 are connected in series between a reference power source Vci and a ground VSS. A switch element S33 and a reference power source voltage accumulating capacity element C3 are connected in series between the reference power source Vci and the connection point of both switch elements S31, S32. A switch element S34 and the capacity element C0 are connected in series between the connection point of the switch element 33 and the capacity element C3, and the ground VSS. The switch elements S31, S32, S33, S34 and the reference power source voltage accumulating capacity element C3 constitute the third step-up circuit unit A3.

One end of the capacity element C0 is connected to the ground VSS, and the other end thereof is connected to the switch elements S14, S24, and S34. As a result, the voltage (Vout) that is twice the reference power source Vci is outputted to the section (connection point between the other end of the capacity element C0 and the switch elements S14, S24, and S34).

Reference numeral 20 is a control unit. The control unit 20 generates control signals A, B, C, D for controlling ON/OFF of the switch elements S11, S12, S13, S14 in the first step-up circuit unit A1, control signals E, F, G, H for controlling the switch elements S21, S22, S23, S24 in the second step-up circuit unit A2, and control signals I, J, K, L for controlling ON/OFF of the switch elements S31, S32, S33, S34 in the third step-up circuit unit A3. The control unit 20 performs a control to carry out electric charge accumulation action or pumping action in the others during a dead-time period of any of the step-up circuit units among the first, second, and third step-up circuits A1, A2, and A3. The control unit 20 carries out this control sequentially and cyclically in the step-up circuits A1, A2, and A3. The reference power source Vci is a power source having no smoothing capacitance.

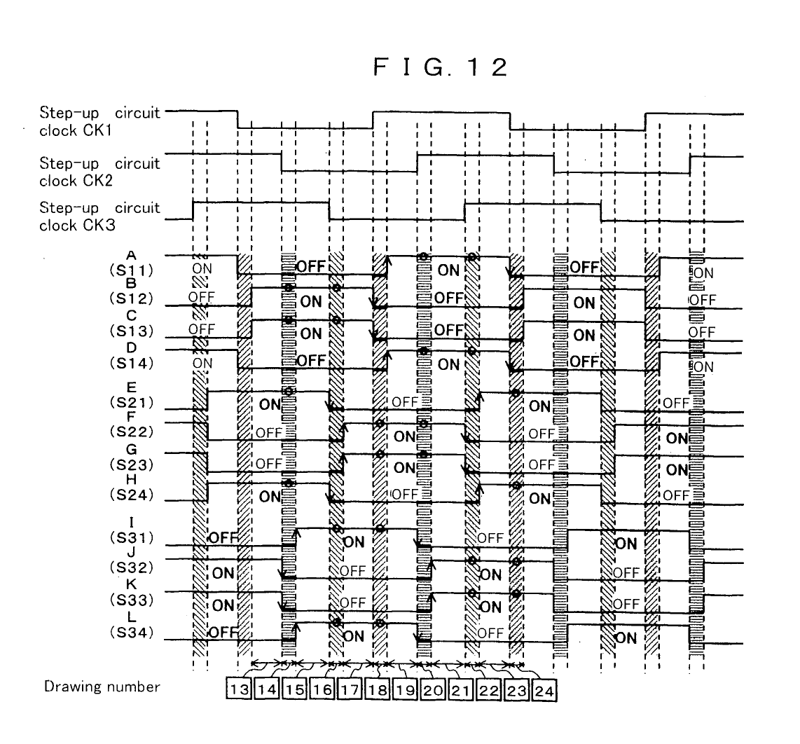

FIG. 12 is a timing chart showing the actions of the step-up device according to this embodiment. In FIG. 12, the control signals A, B, C, and D are generated according to the first clock CK1 for the step-up circuit. The control signals E, F, G, and H are generated according to the second clock CK2 for the step-up circuit. The control signals I, J, K, and L are generated according to the third clock CK3 for the step-up circuit. In FIG. 12, hatching areas are dead-time periods (DT).

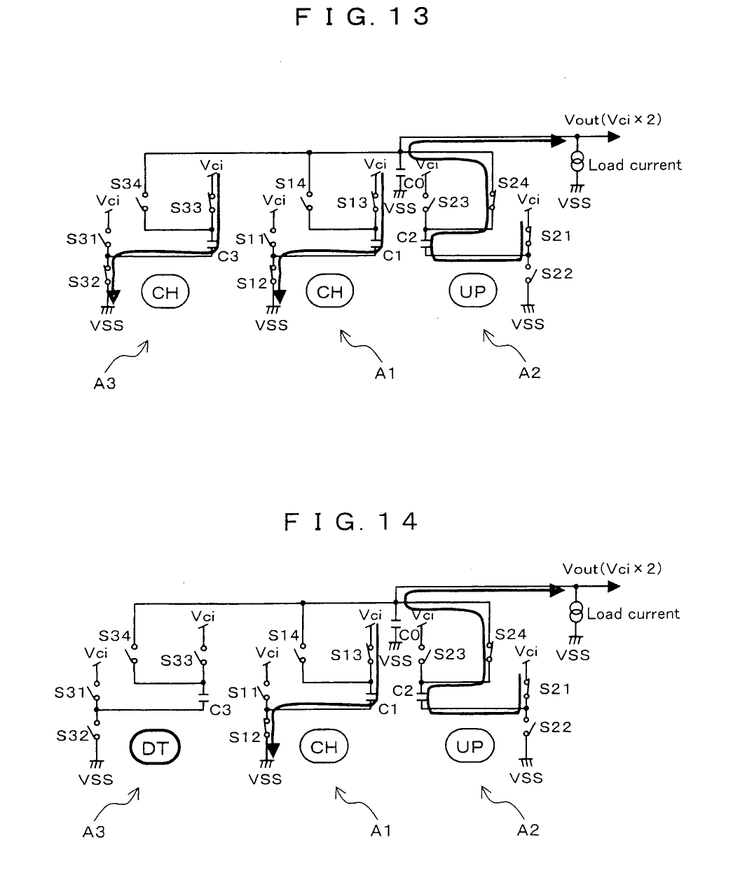

Next, the actions of the step-up device according to this embodiment, which is constituted in the above-described manner, will be described referring to FIG. 13-FIG. 24. First, as shown in FIG. 13, the switch elements S12, S13 of the first step-up circuit unit A1, the switch elements S21, S24 of the second step-up circuit unit A2, and the switch elements S32, S33 of the third step-up circuit unit A3 are turned ON, while the switch elements S11, S14, the switch elements S22, S23, and the switch elements S31, S34 are turned OFF. During this period, the capacity element C1 of the first step-up circuit unit A1 is in the state (CH) of accumulating the reference voltage of the reference power source Vci, the capacity element C2 of the second step-up circuit unit A2 is in the state (UP) of supplying the accumulated electric charge to the capacity element C0 by a pumping action, and the capacity element C3 of the third step-up circuit unit A3 is in the state (CH) of accumulating the reference voltage of the reference power source Vci. During this period, loads at three sections are connected to the reference power source Vci, and the electric charges are supplied from the second step-up circuit unit A2 to the capacity element C0. This state in this period is expressed as [A1, A2, A3]=[CH, UP, CH].

Next, as shown in FIG. 14, the switch elements S32 and S33 in the third step-up circuit unit A3 are turned OFF from the state shown in FIG. 13. In this period, the capacity element C1 in the first step-up circuit unit A1 is in the state (CH) of accumulating the reference voltage of the reference power source Vci, the capacity element C2 of the second step-up circuit unit A2 is in the state (UP) of supplying the accumulated electric charge to the capacity element C0 by a pumping action, and the third step-up circuit unit A3 is in the dead-time period (DT). In this period, the first and the second step-up circuit units A1 and A2 remain the operating state. Thus, the loads at two sections are connected to the reference power source Vci, so that the electric charges are supplied from the second step-up circuit unit A2 to the capacity element C0. The state in this period is expressed as [A1, A2, A3]=[CH, UP, DT].

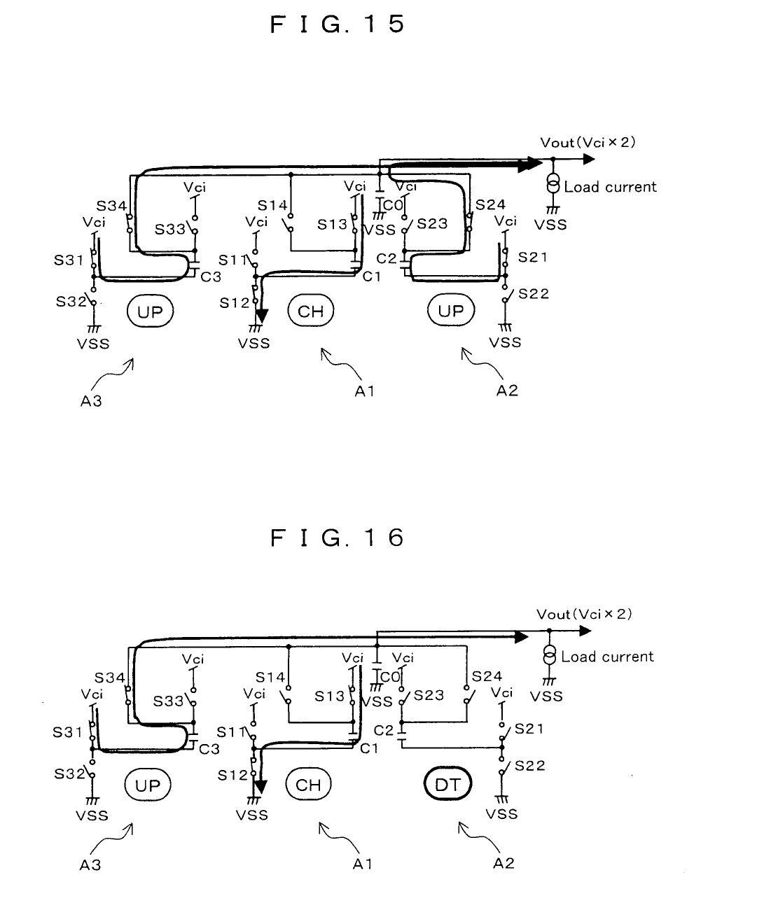

Next, as shown in FIG. 15, the switch elements S31 and S34 in the third step-up circuit unit A3 are turned ON from the state shown in FIG. 14 so as to apply the reference voltage of the reference power source Vci to the capacity element C3 in the inverse direction. In this period, the capacity element C1 in the first step-up circuit unit A1 is in the state (CH) of accumulating the reference voltage of the reference power source Vci, the capacity element C2 in the second step-up circuit unit A2 is in the state (UP) of supplying the accumulated electric charge to the capacity element C0 by a pumping action, and the capacity element C3 in the third step-up circuit unit A3 is in the state (UP) of supplying the accumulated electric charge to the capacity element C0 by a pumping action. In this period, the loads at three sections are connected to the reference power source Vci, and the electric charges are supplied from the second and third step-up circuit units A2 and A3 to the capacity element C0. The state in this period is expressed as [A1, A2, A3]=[CH, UP, UP].

Next, as shown in FIG. 16, the switch elements S21 and S24 in the second step-up circuit unit A2 are turned OFF from the state shown in FIG. 15. In this period, the capacity element C1 in the first step-up circuit unit A1 is in the state (CH) of accumulating the reference voltage of the reference power source Vci, the capacity element C3 in the third step-up circuit unit A3 is in the state (UP) of supplying the accumulated electric charge to the capacity element C0 by a pumping action, and the second step-up circuit unit A2 is in the dead-time period (DT). In this period, the first and third step-up circuit unit A1 and A3 remain in the operating state, so that the loads at two sections are connected to the reference power source Vci. Thus, the electric charges are supplied from the third step-up circuit unit A3 to the capacity element C0. The state in this period is expressed as [A1, A2, A3]=[CH, DT, UP].

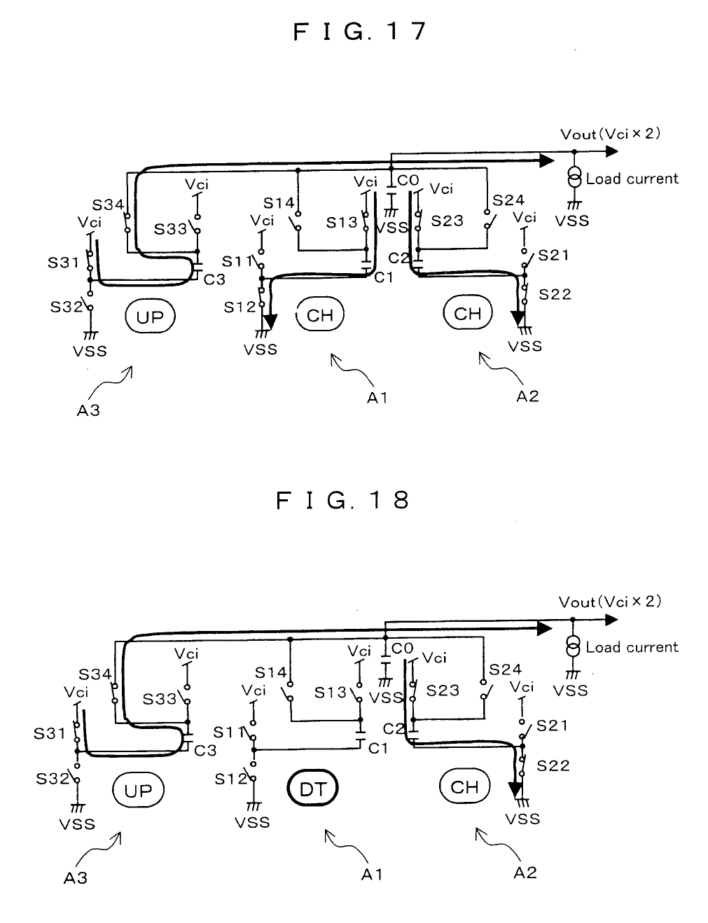

Next, as shown in FIG. 17, the switch elements S22 and S23 of the second step-up circuit unit A2 are turned ON from the state shown in FIG. 16. In this period, the capacity element C1 in the first step-up circuit unit A1 is in the state (CH) of accumulating the reference voltage of the reference power source Vci, the second capacity element C2 in the second step-up circuit unit A2 is in the state (CH) of accumulating the reference voltage of the reference power source Vci, and the capacity element C3 in the third step-up circuit unit A3 is in the state (UP) of supplying the accumulated electric charge to the capacity element C0 by a pumping action. In this period, the loads at three sections are connected to the reference power source Vci, and the electric charges are supplied from the third step-up circuit unit A3 to the capacity element C0. The state in this period is expressed as [A1, A2, A3]=[CH, CH, UP].

Next, as shown in FIG. 18, the switch elements S12 and S13 of the first step-up circuit unit A1 are turned OFF from the state shown in FIG. 17. In this period, the capacity element C2 in the second step-up circuit unit A2 is in the state (CH) of accumulating the reference voltage of the reference power source Vci, the third capacity element C3 in the third step-up circuit unit A3 is in the state (UP) of supplying the accumulated electric charge to the capacity element C0 by a pumping action, and the capacity element C1 in the first step-up circuit unit A1 is in the dead-time period (DT) . In this period, the second and third step-up circuit unit A2 and A3 remain in the operating state, so that the loads at two section are connected to the reference power source Vci, and the electric charges are supplied from the third step-up circuit unit A3 to the capacity element C0. The state in this period is expressed as [A1, A2, A3]=[DT, CH, UP].

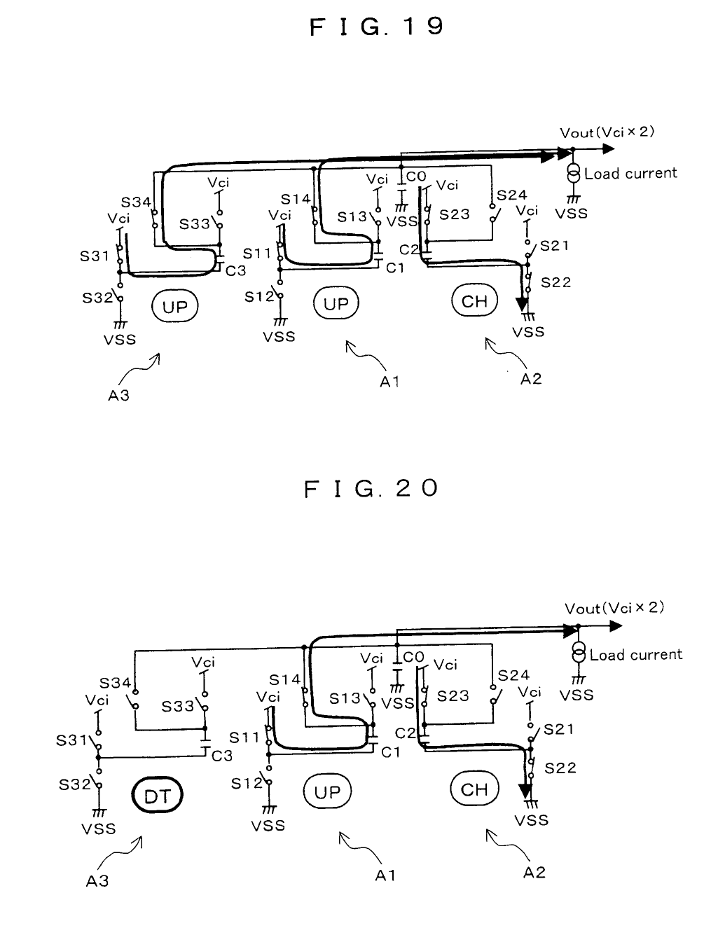

Next as shown in FIG. 19, the switch elements S11 and S14 in the first step-up circuit unit A1 are turned ON from the state shown in FIG. 18 so as to apply the reference voltage of the reference power source Vci to the capacity element C1 in the inverse direction. In this period, the capacity element C1 in the first step-up circuit unit A1 is in the state (UP) of supplying the accumulated electric charge to the capacity element C0 by a pumping action, the capacity element C2 in the second step-up circuit unit A2 is in the state (CH) of accumulating the reference voltage of the reference power source Vci, and the capacity element C3 in the third step-up circuit unit A3 is in the state (UP) of supplying the accumulated electric charge to the capacity element C0 by a pumping action. In this period, the loads at three sections are connected to the reference power source Vci, and the electric charges are supplied from the first and third step-up circuit units A1 and A3 to the capacity element C0. The state in this period is expressed as [A1, A2, A3]=[UP, CH, UP].

Next, as shown in FIG. 20, the switch elements S31 and S34 in the third step-up circuit unit A3 are turned OFF from the state shown in FIG. 19. In this period, the capacity element C1 in the first step-up circuit unit A1 is in the state (UP) of supplying the accumulated electric charge to the capacity element C0 by a pumping action, the capacity element C2 in the second step-up circuit unit A2 is in the state (CH) of accumulating the reference voltage of the reference power source Vci, and the third step-up circuit unit A3 is in the dead-time period (DT). In this period, the first and second step-up circuit units A1 and A2 remain in the operating state, so that the loads at two sections are connected to the reference power source Vci, and the electric charges are supplied from the first step-up circuit unit A1 to the capacity element C0. The state in this period is expressed as [A1, A2, A3]=[UP, CH, DT].

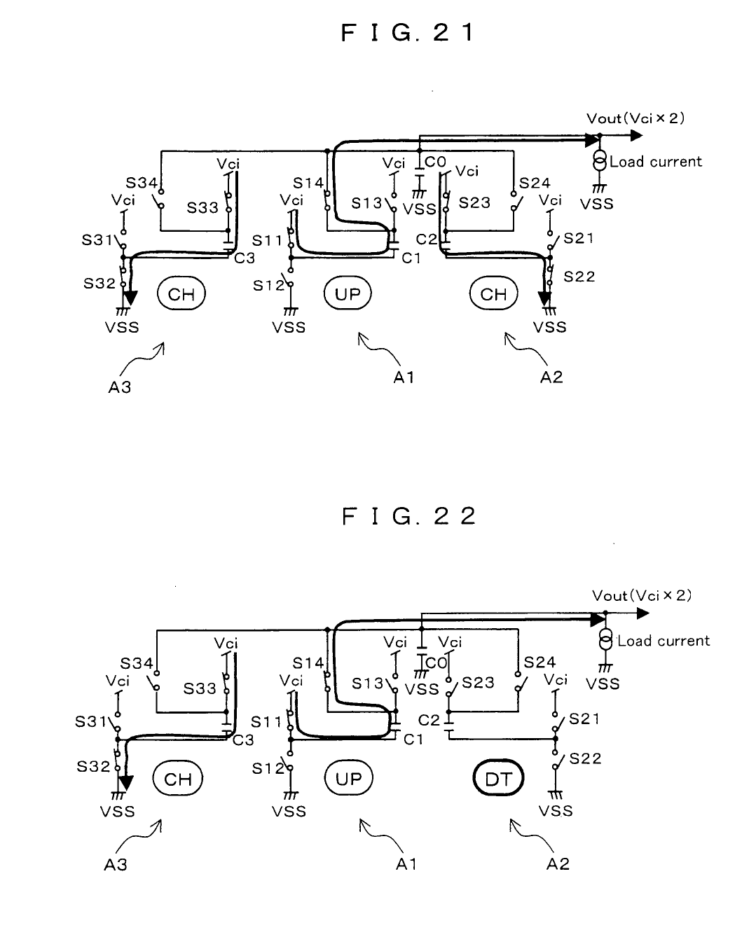

Next, as shown in FIG. 21, the switch elements S32 and S32 in the third step-up circuit unit A3 are turned ON from the state shown in FIG. 20. In this period, the capacity element C1 in the first step-up circuit unit A1 is in the state (UP) of supplying the accumulated electric charge to the capacity element C0 by a pumping action, the capacity element C2 in the second step-up circuit unit A2 is in the state (CH) of accumulating the reference voltage of the reference power source Vci, and the third step-up circuit unit A3 is in the state (CH) of accumulating the reference voltage of the reference power source Vci. In this period, the loads at three sections are connected to the reference power source Vci, and the electric charges are supplied from the first step-up circuit unit A1 to the capacity element C0. The state in this period is expressed as [A1, A2, A3]=[UP, CH, CH].

Next, as shown in FIG. 22, the switch elements S22 and S23 in the second step-up circuit unit A2 are turned OFF from the state shown in FIG. 21. In this period, the capacity element C1 in the first step-up circuit unit A1 is in the state (UP) of supplying the accumulated electric charge to the capacity element C0 by a pumping action, the capacity element C3 in the third step-up circuit unit A3 is in the state (CH) of accumulating the reference voltage of the reference power source Vci, and the second step-up circuit unit A2 is in the dead-time period (DT). In this period, the first and third step-up circuit units A1 and A3 remain in the operating state, so that the loads at two sections are connected to the reference power source Vci, and the electric charges are supplied from the first step-up circuit unit A1 to the capacity element C0. The state in this period is expressed as [A1, A2, A3]=[UP, DT, CH].

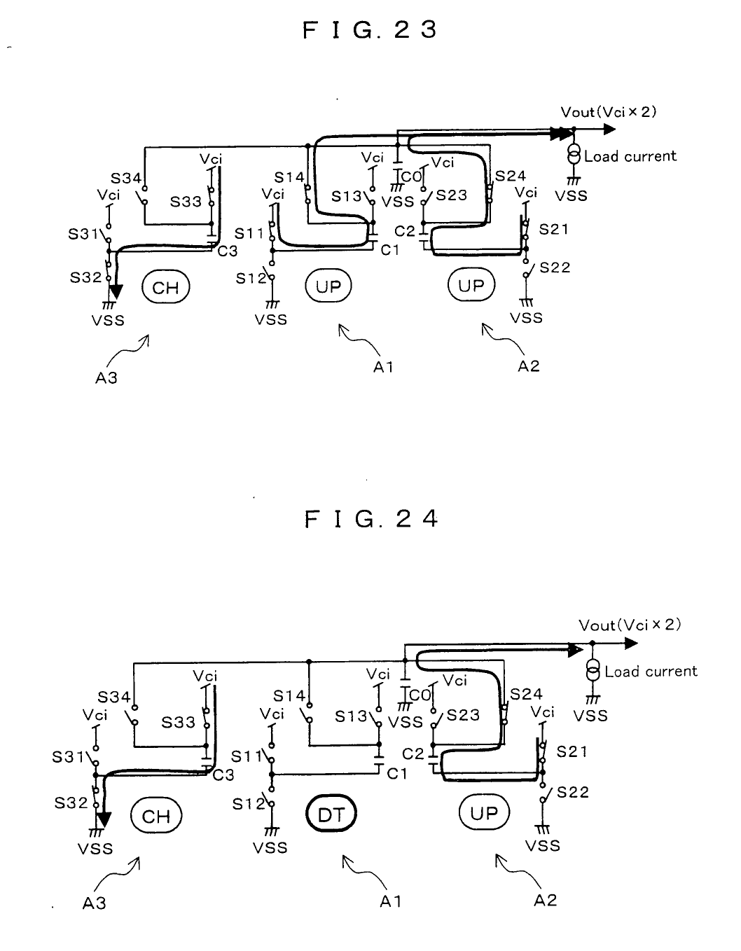

Next, as shown in FIG. 23, the switch elements S21 and S24 in the second step-up circuit unit A2 are turned ON from the state shown in FIG. 22 so as to apply the reference voltage of the reference power source Vci to the capacity element C2 in the inverse direction. In this period, the capacity element C1 in the first step-up circuit unit A1 is in the state (UP) of supplying the accumulated electric charge to the capacity element C0 by a pumping action, the capacity element C2 in the second step-up circuit unit A2 is in the state (UP) of supplying the accumulated electric charge to the capacity element C0 by a pumping action, and the capacity element C3 in the third step-up circuit unit A1 is in the state (CH) of accumulating the reference voltage of the reference power source Vci. In this period, the loads at three sections are connected to the reference power source Vci, and the electric charges are supplied from the first and the second step-up circuit units A1 and A2 to the capacity element C0. The state in this period is expressed as [A1, A2, A3]=[UP, UP, CH].

Next, as shown in FIG. 24, the switch elements S11 and S14 in the first step-up circuit unit A1 are turned OFF from the state shown in FIG. 23. In this period, the capacity element C2 in the second step-up circuit unit A2 is in the state (UP) of supplying the accumulated electric charge to the capacity element C0 by a pumping action, the capacity element C3 in the third step-up circuit unit A3 is in the state (CH) of accumulating the reference voltage of the reference power source Vci, and the first step-up circuit unit A1 is in the dead-time period (DT) . In this period, the second and third step-up circuit units A2 and A3 remain in the operating state, so that the loads at two sections are connected to the reference power source Vci, and the electric charges are supplied from the second step-up circuit unit A2 to the capacity element C0. The state in this period is expressed as [A1, A2, A3]=[DT, UP, CH].

Through repeating the actions shown in FIG. 13-FIG. 24, the voltage (Vout) that is twice the reference power source Vci is generated in the capacity element C0.

In the period in FIG. 12, which corresponds to the state shown in FIG. 14, all of the four switch elements S31, S32, S33, and S34 in the third step-up circuit unit A3 are turned OFF, so that the third step-up circuit unit A3 is in the dead-time period (DT). At this time, the switch elements S12 and S13 are ON in the first step-up circuit unit A1, so that the state (CH) of accumulating the reference voltage of the reference power source Vci can be secured therein. The switch elements S21 and S24 are ON in the second step-up circuit unit A2, so that the state (UP) of supplying the accumulated electric charge to the capacity element C0 can be secured therein.

Further, in the period in FIG. 12, which corresponds to the state shown in FIG. 16, all of the four switch elements S21, S22, S23, and S24 in the second step-up circuit unit A2 are turned OFF, so that the second step-up circuit unit A2 is in the dead-time period (DT). At this time, the switch elements S12 and S13 are ON in the first step-up circuit unit A1, so that the state (CH) of accumulating the reference voltage of the reference power source Vci can be secured therein. The switch elements S31 and S34 are ON in the third step-up circuit unit A3, so that the state (UP) of supplying the accumulated electric charge to the capacity element C0 can be secured therein.

In the period in FIG. 12, which corresponds to the state shown in FIG. 18, all of the four switch elements S11, S12, S13, and S14 in the first step-up circuit unit A1 are turned OFF, so that the first step-up circuit unit A1 is in the dead-time period (DT). At this time, the switch elements S22 and S23 are ON in the second step-up circuit unit A2, so that the state (CH) of accumulating the reference voltage of the reference power source Vci can be secured therein. The switch elements S31 and S34 are ON in the third step-up circuit unit A3, so that the state (UP) of supplying the accumulated electric charge to the capacity element C0 can be secured therein.

In the period in FIG. 12, which corresponds to the state shown in FIG. 20, all of the four switch elements S31, S32, S33, and S34 in the third step-up circuit unit A3 are turned OFF, so that the third step-up circuit unit A3 is in the dead-time period (DT). At this time, the switch elements S22 and S23 are ON in the second step-up circuit unit A2, so that the state (CH) of accumulating the reference voltage of the reference power source Vci can be secured therein. The switch elements S11 and S14 are ON in the first step-up circuit unit A1, so that the state (UP) of supplying the accumulated electric charge to the capacity element C0 can be secured therein.

In the period in FIG. 12, which corresponds to the state shown in FIG. 22, all of the four switch elements S21, S22, S23, and S24 in the second step-up circuit unit A2 are turned OFF, so that the second step-up circuit unit A2 is in the dead-time period (DT). At this time, the switch elements S32 and S33 are ON in the third step-up circuit unit A3, so that the state (CH) of accumulating the reference voltage of the reference power source Vci can be secured therein. The switch elements S11 and S14 are ON in the first step-up circuit unit A1, so that the state (UP) of supplying the accumulated electric charge to the capacity element C0 can be secured therein.

In the period in FIG. 12, which corresponds to the state shown in FIG. 24, all of the four switch elements S11, S12, S13, and S14 in the first step-up circuit unit A1 are turned OFF, so that the first step-up circuit unit A1 is in the dead-time period (DT). At this time, the switch elements S32 and S33 are ON in the third step-up circuit unit A3, so that the state (CH) of accumulating the reference voltage of the reference power source Vci can be secured therein. The switch elements S21 and S24 are ON in the second step-up circuit unit A2, so that the state (UP) of supplying the accumulated electric charge to the capacity element C0 can be secured therein.

The states described above can be summarized as follows.
FIG. 13−[A1, A2, A3]=[CH, UP, CH]
FIG. 14−[A1, A2, A3]=[CH, UP, DT]
FIG. 15−[A1, A2, A3]=[CH, UP, UP]
FIG. 16−[A1, A2, A3]=[CH, DT, UP]
FIG. 17−[A1, A2, A3]=[CH, CH, UP]
FIG. 18−[A1, A2, A3]=[DT, CH, UP]
FIG. 19−[A1, A2, A3]=[UP, CH, UP]
FIG. 20−[A1, A2, A3]=[UP, CH, DT]
FIG. 21−[A1, A2, A3]=[UP, CH, CH]
FIG. 22−[A1, A2, A3]=[UP, DT, CH]
FIG. 23−[A1, A2, A3]=[UP, UP, CH]
FIG. 24−[A1, A2, A3]=[DT, UP, CH]

Looking at the record of the actions in the first step-up circuit unit A1, it is a cyclic action of CH→CH→CH→CH→CH→DT→UP→UP→UP→UP→UP→DT. Looking at the record of the actions in the second step-up circuit unit A2, it is a cyclic action of UP→UP→UP→DT→CH→CH→CH→CH→CH→DT→UP→UP. Looking at the record of the actions in the third step-up circuit unit A3, it is a cyclic action of CH→DT→UP→UP→UP→UP→UP→DT→CH→CH→CH→CH. The actions of the three step-up circuit units A1, A2, and A3 are the cyclic actions of the same pattern though the timings thereof are different.

When the third step-up circuit unit A3 is in the dead-time period (DT) (in the state of FIG. 14 or FIG. 20), the first step-up circuit unit A1 is in the state (CH) of accumulating the reference voltage of the reference power source Vci or in the state (UP) of supplying the accumulated electric charge to the capacity element C0 by a pumping action, and the second step-up circuit unit A2 is in the state (UP) of supplying the accumulated electric charge to the capacity element C0 or in the state (CH) of accumulating the reference voltage of the reference power source Vci.

Furthermore, when the second step-up circuit unit A2 is in the dead-time period (DT) (in the state of FIG. 16 or FIG. 22), the first step-up circuit unit A1 is in the state (CH) of accumulating the reference voltage of the reference power source Vci or in the state (UP) of supplying the accumulated electric charge to the capacity element C0 by the pumping action, and the third step-up circuit unit A3 is in the state (UP) of supplying the accumulated electric charge to the capacity element C0 or in the state (CH) of accumulating the reference voltage of the reference power source Vci.

Moreover, when the first step-up circuit unit A1 is in the dead-time period (DT) (in the state of FIG. 18 or FIG. 24), the second step-up circuit unit A2 is in the state (CH) of accumulating the reference voltage of the reference power source Vci or in the state (UP) of supplying the accumulated electric charge to the capacity element C0 by a pumping action, and the third step-up circuit unit A3 is in the state (UP) of supplying the accumulated electric charge to the capacity element C0 or in the state (CH) of accumulating the reference voltage of the reference power source Vci.

That is, even if any of the step-up circuit units is in the dead-time period (DT), one of the other step-up circuit units always keep the state where a load is connected to the reference power source Vci that has no smoothing capacitance. The [DT, no load] state in the case of the conventional technique is thereby solved, so that noise generated due to the [DT, no load] state can be suppressed. In addition, another of the other step-up circuit units always keeps the state where the electric charges are supplied to the capacity element C0. It is possible based on this to achieve the effect of reducing ripples caused by the voltage (Vout) that is twice the reference voltage of the reference power source Vci and the effect of improving the current capacity.

In short, it is possible according to the embodiment to achieve the boost-up action and noise reduction in the reference power source Vci, under the state where the load is always imposed upon the reference power source Vci. Furthermore, as electric charges are always supplied to the capacity element C0 from at least one of the step-up circuit units, it is possible to obtain the effect of reducing ripples caused by the voltage (Vout) that is twice the reference voltage of the reference power source Vci and the effect of improving the current capacity.

In the step-up device of this embodiment, the electric charges are always supplied from at least one of the step-up circuit units to the output terminal that outputs the voltage (Vout) that is twice the reference voltage of the reference power source Vci. Thus, it is possible to omit the step-up voltage accumulating capacity element C0 that serves as a function to keep the voltage (Vout) that is twice the reference voltage of the reference power source Vci.

### Third Embodiment

The first and second embodiments have been described referring to the case where the present invention is achieved with the structure of the step-up device. However, the same effects as those described above can be achieved with a step-down device in which three or more step-down circuit units are connected. The step-down device according to a third embodiment of the present invention will be described hereinafter.

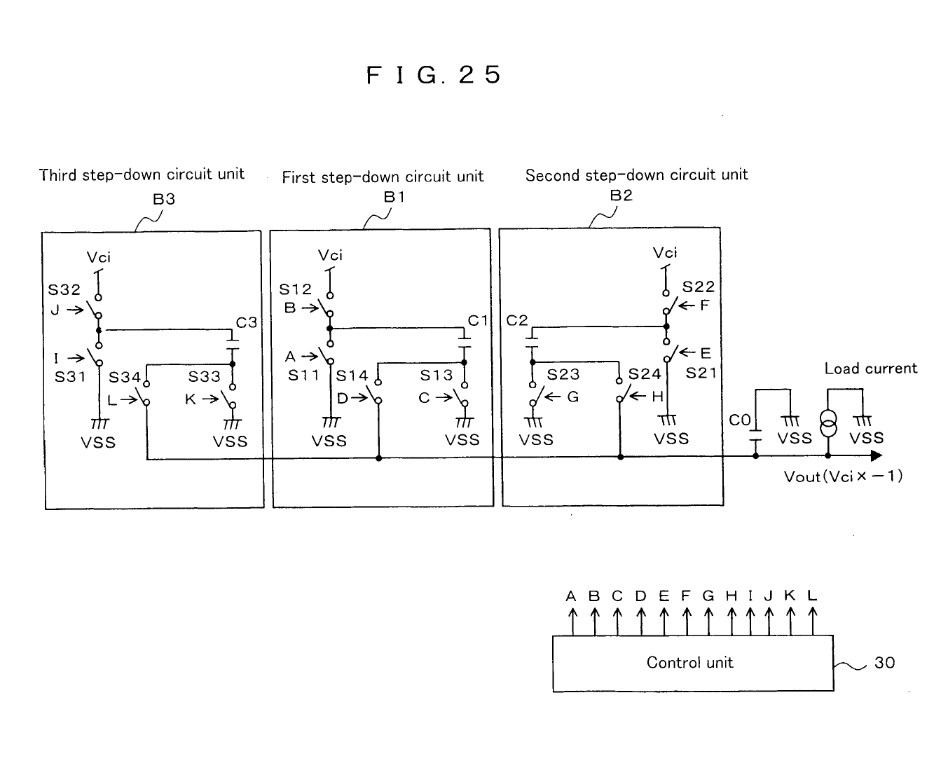

FIG. 25 is a circuit block diagram showing the structure of the step-down device according to the third embodiment of the present invention. A step-down voltage accumulating capacity element C0 is connected to a voltage output terminal Vout. A first step-down circuit unit B1, a second step-down circuit unit B2, and a third step-down circuit unit B3 are connected in parallel to the capacity element C0. The capacity element C0 keeps and outputs a voltage (Vout) that is (−1)-time the reference power source Vci.

In the first step-down circuit unit B1, switch elements S11 and S12 are connected in series between a ground VSS and a reference power source Vci. A switch element S13 and a reference power source voltage accumulating capacity element C1 are connected in series between the ground VSS and the connection point of both switch elements S21, S22. A switch element S14 and the capacity element C0 are connected in series between the connection point of the switch element 13 and the capacity element C0, and the ground VSS. The capacity element C0 keeps and outputs the voltage (Vout) that is (−1)-time the reference power source Vci. The switch elements S11, S12, S13, S14 and the capacity element C1 constitute the first step-down circuit unit B1.

In the second step-down circuit unit B2, switch elements S21 and S22 are connected in series between a ground VSS and a reference power source Vci. A switch element S23 and a reference power source voltage accumulating capacity element C2 are connected in series between the ground VSS and the connection point of both switch elements S21, S22. A switch element S24 and the capacity element C0 are connected in series between the connection point of the switch element 23 and the capacity element C2, and the ground VSS. The switch elements S21, S22, S23, S24 and the capacity element C2 constitute the second step-down circuit unit B2.

In the third step-down circuit unit B3, switch elements S31 and S32 are connected in series between a ground VSS and a reference power source Vci. A switch element S33 and a reference power source voltage accumulating capacity element C3 are connected in series between the ground VSS and the connection point of both switch elements S31, S32. A switch element S34 and the capacity element C0 are connected in series between the connection point of the switch element 33 and the capacity element C3, and the ground VSS. The switch elements S31, S32, S33, S34 and the capacity element C3 constitute the third step-up step-down unit B3.

Reference numeral 30 is a control unit. The control unit 30 generates control signals A, B, C, D for controlling ON/OFF of the switch elements S11, S12, S13, S14 in the first step-down circuit unit B1, control signals E, F, G, H for controlling the switch elements S21, S22, S23, S24 in the second step-down circuit unit B2, and control signals I, J, K, L for controlling ON/OFF of the switch elements S31, S32, S33, S34 in the third step-down circuit unit B3. The control unit 30 performs a control to carry out electric charge accumulation action or pumping action in one of the step-down circuit units during a dead-time period of other step-down circuits among the first, second, and third step-down circuits B1, B2, and B3. The control unit 30 carries out this control sequentially and cyclically in the step-down circuits B1, B2, and B3. The reference power source Vci is a power source having no smoothing capacitance.

In the step-down device according to this embodiment, the first, second, and third step-down circuit units B1, B2, and B3 are connected in parallel to the step-down voltage accumulating capacity element C0 that holds the voltage (Vout) that is (−1)-time the reference voltage of the reference power source Vci.

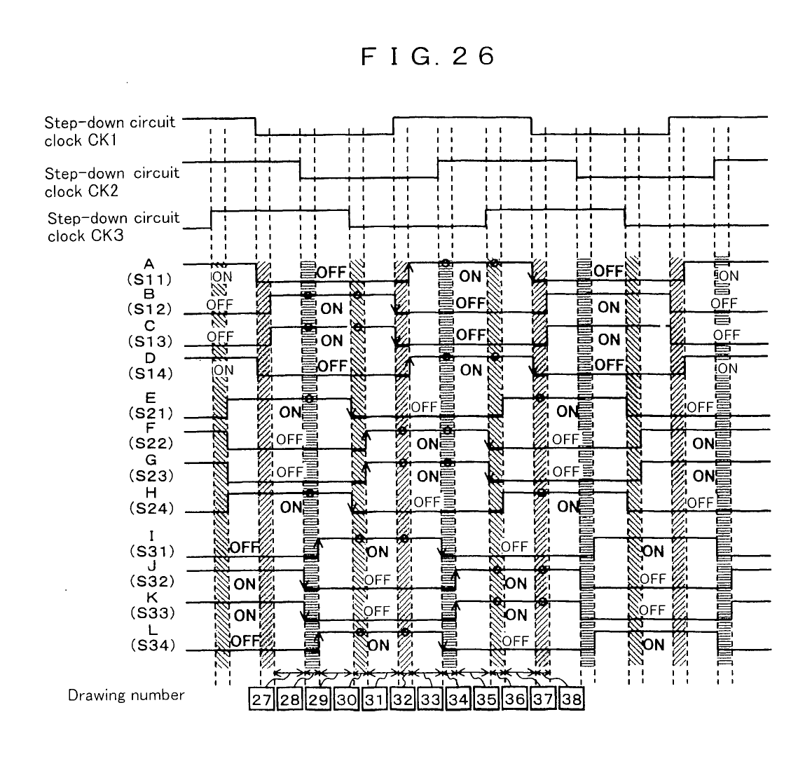

FIG. 26 is a timing chart showing the actions of the step-down device according to this embodiment. In the timing chart shown in FIG. 26, the control signals A, B, C, and D are generated according to the first clock CK1 for the step-down circuit. The control signals E, F, G, and H are generated according to the second clock CK2 for the step-down circuit. The control signals I, J, K, and L are generated according to the third clock CK3 for the step-down circuit. In FIG. 26, hatching areas are dead-time periods (DT).

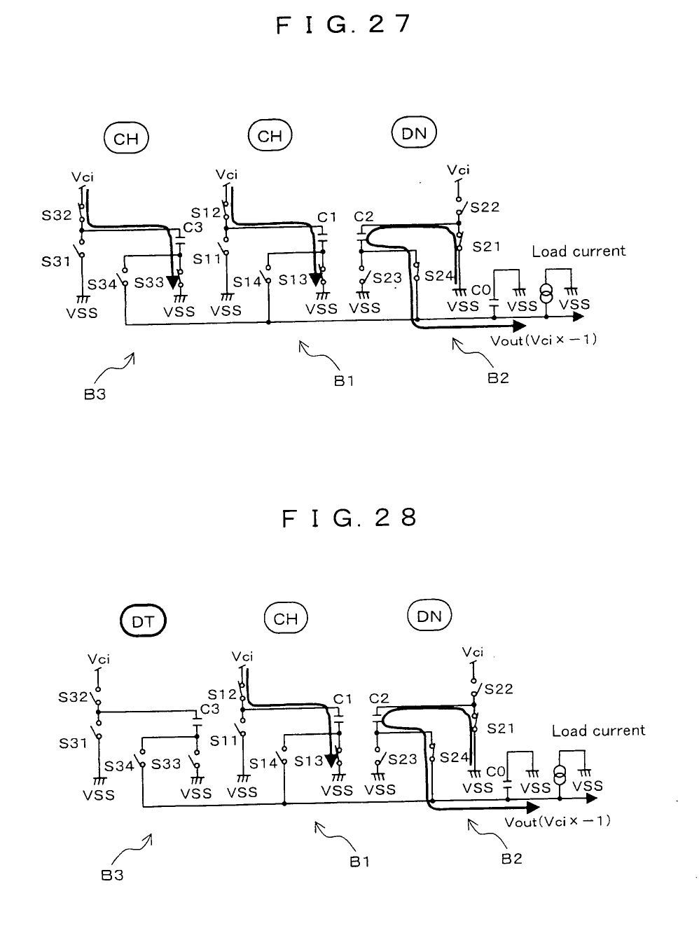

Next, the actions of the step-down device according to this embodiment that is constituted in the above-described manner will be described referring to FIG. 27-FIG. 38. First, as shown in FIG. 27, the switch elements S12, S13 of the first step-down circuit unit B1, the switch elements S21, S24 of the second step-down circuit unit B2, and the switch elements S32, S33 of the third step-down circuit unit B3 are turned ON, while the switch elements S11, S14, the switch elements S22, S23, and the switch elements S31, S34 are turned OFF. During this period, the capacity element C1 of the first step-down circuit unit B1 is in the state (CH) of accumulating the reference voltage of the reference power source Vci, the capacity element C2 of the second step-down circuit unit B2 is in the state (DN) of supplying the accumulated electric charge to the capacity element C0, and the capacity element C3 of the third step-down circuit unit B3 is in the state (CH) of accumulating the reference voltage of the reference power source Vci. During this period, loads at two sections are connected to the reference power source Vci, and the electric charges are supplied from the second step-down circuit unit B2 to the capacity element C0. This state in this period is expressed as [B1, B2, B3]=[CH, DN, CH].

Next, as shown in FIG. 28, the switch elements S32 and S33 in the third step-down circuit unit B3 are turned OFF from the state shown in FIG. 27. In this period, the capacity element C1 in the first step-down circuit unit B1 is in the state (CH) of accumulating the reference voltage of the reference power source Vci, the capacity element C2 of the second step-down circuit unit B2 is in the state (DN) of supplying the accumulated electric charge to the capacity element C0, and the third step-down circuit unit B3 is in the dead-time period (DT). The first and the second step-down circuit units B1 and B2 remain in the operating state. Thus, the load at one section is connected to the reference power source Vci, and the electric charges are supplied from the second step-down circuit unit B2 to the capacity element C0. The state in this period is expressed as [B1, B2, B3]=[CH, DN, DT].

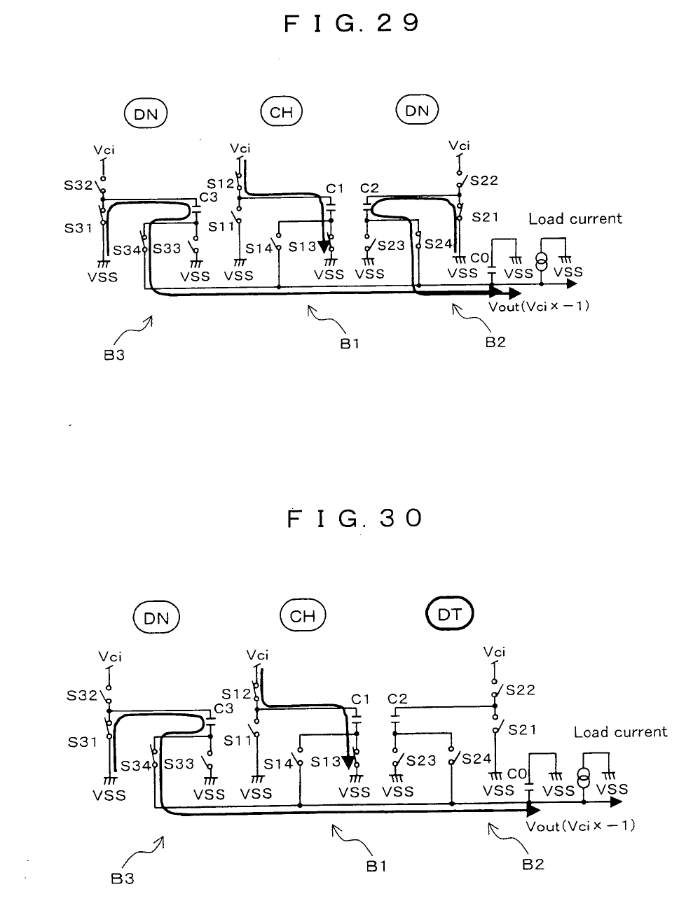

Next, as shown in FIG. 29, the switch elements S31 and S34 in the third step-down circuit unit B3 are turned ON from the state shown in FIG. 28 so as to apply the reference voltage of the reference power source Vci to the capacity element C3 in the same direction. In this period, the capacity element C1 in the first step-down circuit unit B1 is in the state (CH) of accumulating the reference voltage of the reference power source Vci, the capacity element C2 in the second step-down circuit unit A2 is in the state (DN) of supplying the accumulated electric charge to the capacity element C0, and the capacity element C3 in the third step-down circuit unit B3 is in the state (DN) of supplying the accumulated electric charge to the capacity element C0. In this period, the load at one section is connected to the reference power source Vci, and the electric charges are supplied from the second and third step-down circuit units B2 and B3 to the capacity element C0. The state in this period is expressed as [B1, B2, B3]=[CH, DN, DN].

Next, as shown in FIG. 30, the switch elements S21 and S24 in the second step-dow- circuit unit B2 are turned OFF from the state shown in FIG. 29. In this period, the capacity element C1 in the first step-down circuit unit B1 is in the state (CH) of accumulating the reference voltage of the reference power source Vci, the capacity element C3 in the third step-down circuit unit B3 is in the state (DN) of supplying the accumulated electric charge to the capacity element C0 by a pumping action, and the second step-down circuit unit B2 is in the dead-time period (DT). In this period, the first and third step-down circuit unit B1 and B3 remain in the operating state, and the load at one section is connected to the reference power source Vci. Thus, the electric charges are supplied from the third step-down circuit unit B3 to the capacity element C0. The state in this period is expressed as [B1, B2, B3][CH, DT, DN].

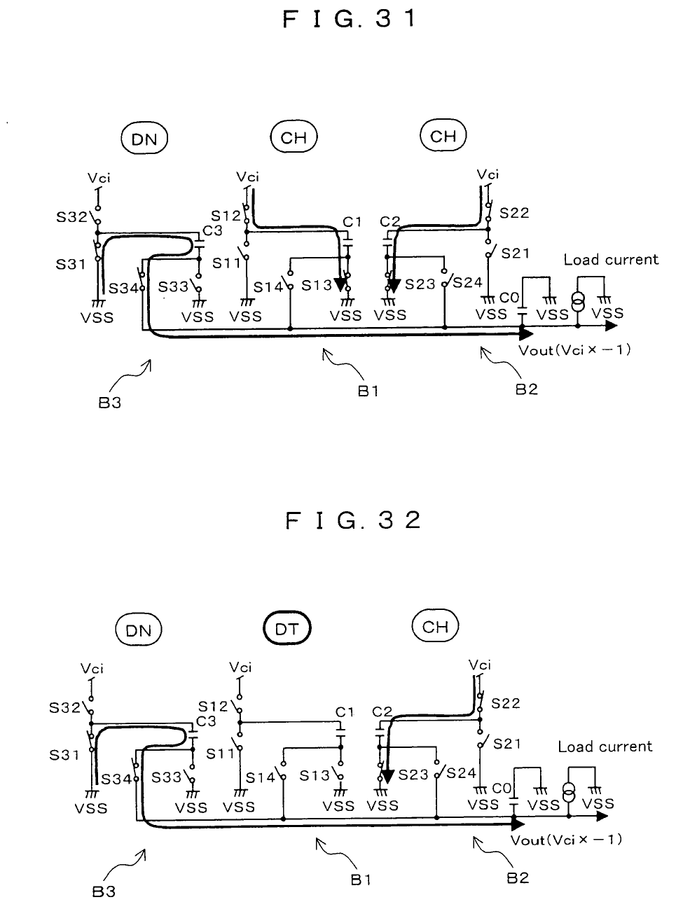

Next, as shown in FIG. 31, the switch elements S22 and S23 of the second step-down circuit unit B2 are turned ON from the state shown in FIG. 30. In this period, the capacity element C1 in the first step-down circuit unit B1 is in the state (CH) of accumulating the reference voltage of the reference power source Vci, the second capacity element C2 in the second step-down circuit unit B2 is in the state (CH) of accumulating the reference voltage of the reference power source Vci, and the capacity element C3 in the third step-down circuit unit B3 is in the state (DN) of supplying the accumulated electric charge to the capacity element C0. In this period, the loads at two sections are connected to the reference power source Vci, and the electric charges are supplied from the third step-down circuit unit B3 to the capacity element C0. The state in this period is expressed as [B1, B2, B3][CH, CH, DN].

Next, as shown in FIG. 32, the switch elements S12 and S13 in the first step-down circuit unit B1 are turned OFF from the state shown in FIG. 31. In this period, the capacity element C2 in the second step-down circuit unit B2 is in the state (CH) of accumulating the reference voltage of the reference power source Vci, the third capacity element C3 in the third step-down circuit unit B3 is in the state (DN) of supplying the accumulated electric charge to the capacity element C0, and the capacity element C1 in the first step-down circuit unit B1 is in the dead-time period (DT). In this period, the second and third step-down circuit unit B2 and B3 remain in the operating state, so that the load at-one section is connected to the reference power source Vci and the electric charges are supplied from the third step-down circuit unit B3 to the capacity element C0. The state in this period is expressed as [B1, B2, B3][DT, CH, DN].

Next as shown in FIG. 33, the switch elements S11 and S14 in the first step-down circuit unit B1 are turned ON from the state shown in FIG. 32 so as to apply the reference voltage of the reference power source Vci to the capacity element C1 in the same direction. In this period, the capacity element C1 in the first step-down circuit unit B1 is in the state (DN) of supplying the accumulated electric charge to the capacity element C0, the capacity element C2 in the second step-down circuit unit B2 is in the state (CH) of accumulating the reference voltage of the reference power source Vci, and the capacity element C3 in the third step-down circuit unit B3 is in the state (DN) of supplying the accumulated electric charge to the capacity element C0. In this period, the load at one section is connected to the reference power source Vci, and the electric charges are supplied from the first and third step-down circuit units B1 and B3 to the capacity element C0. The state in this period is expressed as [B1, B2, B3][DN, CH, DN].

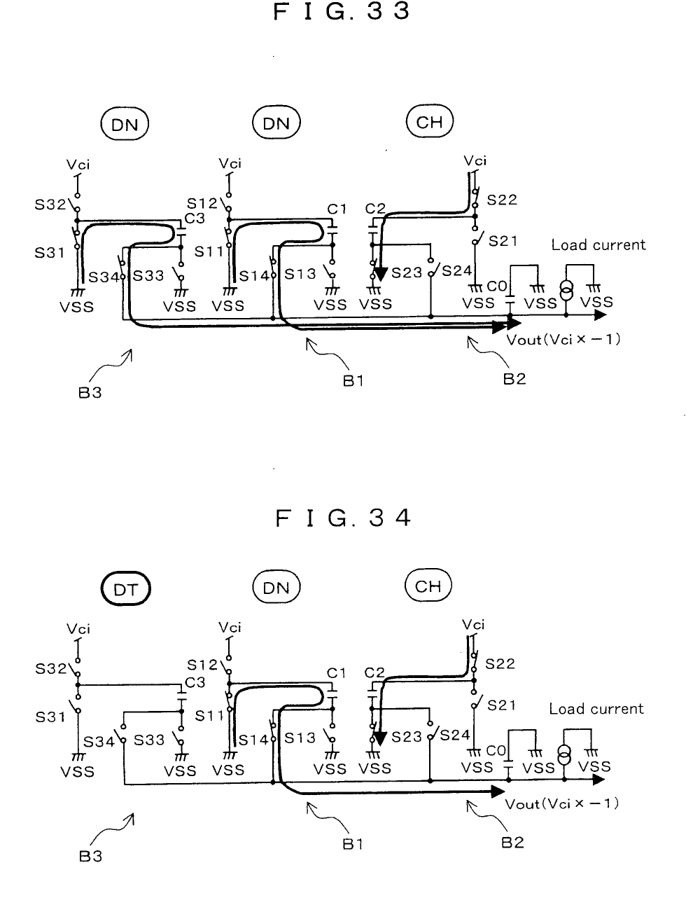

Next, as shown in FIG. 34, the switch elements S31 and S34 in the third step-down circuit unit B3 are turned OFF from the state shown in FIG. 33. In this period, the capacity element C1 in the first step-down circuit unit B1 is in the state (DN) of supplying the accumulated electric charge to the capacity element C0, the capacity element C2 in the second step-down circuit unit B2 is in the state (CH) of accumulating the reference voltage of the reference power source Vci, and the third step-up circuit unit B3 is in the dead-time period (DT). In this period, the first and second step-down circuit units B1 and B2 remain in the operating state, so that the load at one section is connected to the reference power source Vci and the electric charges are supplied from the first step-down circuit unit B1 to the capacity element C0. The state in this period is expressed as [B1, B2, B3][DN, CH, DT].

Next, as shown in FIG. 35, the switch elements S32 and S33 in the third step-down circuit unit B3 are turned ON from the state shown in FIG. 34. In this period, the capacity element C1 in the first step-down circuit unit B1 is in the state (DN) of supplying the accumulated electric charge to the capacity element C0, the capacity element C2 in the second step-down circuit unit B2 is in the state (CH) of accumulating the reference voltage of the reference power source Vci, and the capacity element C3 in the third step-down circuit unit B3 is in the state (CH) of accumulating the reference voltage of the reference power source Vci. In this period, the loads at two sections are connected to the reference power source Vci, and the electric charges are supplied from the first step-down circuit unit B1 to the capacity element C0. The state in this period is expressed as [B1, B2, B3][DN, CH, CH].

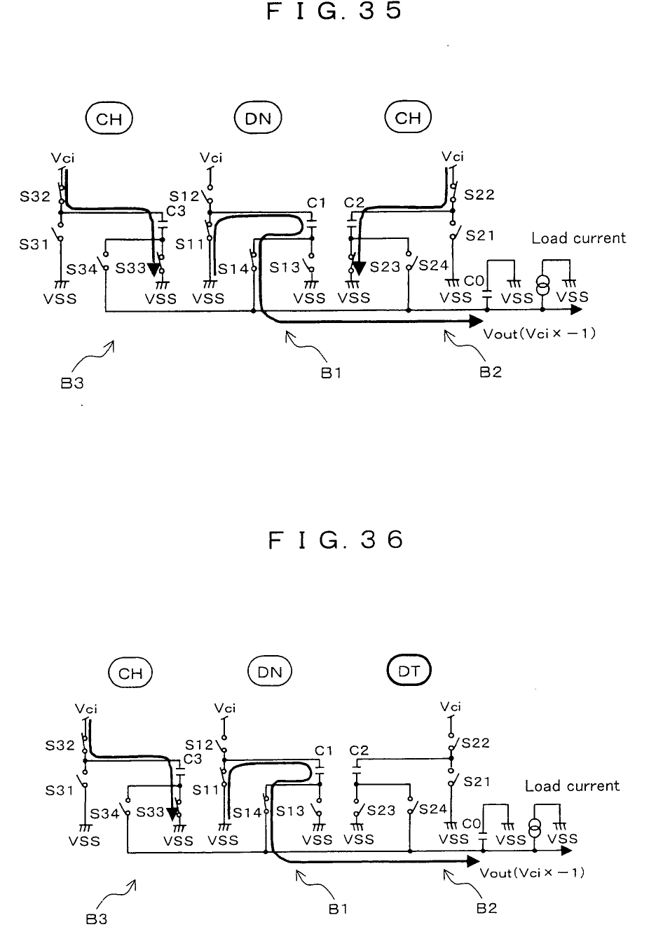

Next, as shown in FIG. 36, the switch elements S22 and S23 in the second step-down circuit unit B2 are turned OFF from the state shown in FIG. 35. In this period, the capacity element C1 in the first step-down circuit unit B1 is in the state (DN) of supplying the accumulated electric charge to the capacity element C0, the capacity element C3 in the third step-down circuit unit B3 is in the state (CH) of accumulating the reference voltage of the reference power source Vci, and the second step-down circuit unit B2 is in the dead-time period (DT). In this period, the first and third step-down circuit units B1 and B3 remain in the operating state, so that the load at one section is connected to the reference power source Vci and the electric charges are supplied from the first step-down circuit unit B1 to the capacity element C0. The state in this period is expressed as [B1, B2, B3][DN, DT, CH].

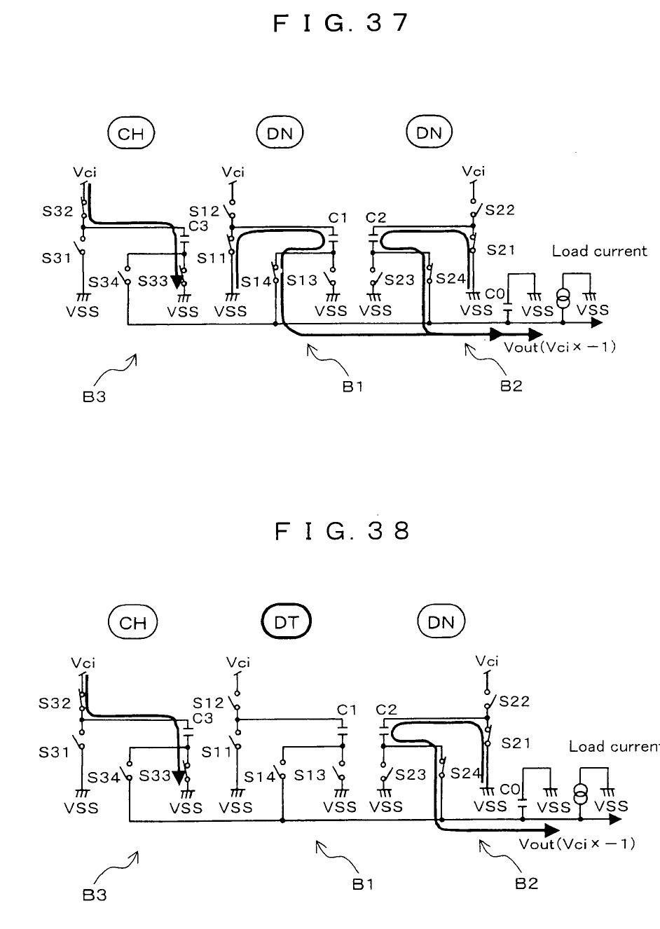

Next, as shown in FIG. 37, the switch elements S21 and S24 in the second step-down circuit unit B2 are turned ON from the state shown in FIG. 36 so as to apply the reference voltage of the reference source Vci to the capacity element C2 in the same direction. In this period, the capacity element C1 in the first step-down circuit unit B1 is in the state (DN) of supplying the accumulated electric charge to the capacity element C0, the capacity element C2 in the second step-down circuit unit B2 is in the state (DN) of supplying the accumulated electric charge to the capacity element C0, and the capacity element C3 in the third step-down circuit unit B3 is in the state (CH) of accumulating the reference voltage of the reference power source Vci. In this period, the load at one section is connected to the reference power source Vci, and the electric charges are supplied from the first and the second step-down circuit units B1 and B2 to the capacity element C0. The state in this period is expressed as [B1, B2, B3][DN, DN, CH].

Next, as shown in FIG. 38, the switch elements S11 and S14 in the first step-down circuit unit B1 are turned OFF from the state shown in FIG. 37. In this period, the capacity element C2 in the second step-down circuit unit B2 is in the state (DN) of supplying the accumulated electric charge to the capacity element C0, the capacity element C3 in the third step-down circuit unit B3 is in the state (CH) of accumulating the reference voltage of the reference power source Vci, and the first step-down circuit unit B1 is in the dead-time period (DT). In this period, the second and third step-down circuit units B2 and B3 remain in the operating state, so that the load at one section is connected to the reference power source Vci and the electric charges are supplied from the second step-down circuit unit B2 to the capacity element C0. The state in this period is expressed as [B1, B2, B3]=[DT, DN, CH].

Through repeating the actions shown in FIG. 27-FIG. 38, the voltage (Vout) that is (−1) -time the reference power source Vci is generated in the capacity element C0.

In the period in FIG. 26, which corresponds to the state shown in FIG. 28, all of the four switch elements S31, S32, S33, and S34 in the third step-down circuit unit B3 are turned OFF, so that the third step-down circuit unit B3 is in the dead-time period (DT). At this time, the switch elements S12 and S13 are ON in the first step-down circuit unit B1, so that the state (CH) of accumulating the reference voltage of the reference power source Vci can be secured therein. The switch elements S21 and S24 are ON in the second step-down circuit unit B2, so that the state (DN) of supplying the accumulated electric charge to the capacity element C0 can be secured therein.

Further, in the period in FIG. 26, which corresponds to the state shown in FIG. 30, all of the four switch elements S21, S22, S23, and S24 in the second step-down circuit unit B2 are turned OFF, so that the second step-down circuit unit B2 is in the dead-time period (DT). At this time, as the switch elements S12 and S13 are ON in the first step-down circuit unit B1, the state (CH) of accumulating the reference voltage of the reference power source Vci can be secured therein. Because the switch elements S31 and S34 are ON in the third step-down circuit unit B3, the state (DN) of supplying the accumulated electric charge to the capacity element C0 can be secured therein.

In the period of FIG. 26, which corresponds to the state shown in FIG. 32, all of the four switch elements S11, S12, S13, and S14 in the first step-down circuit unit B1 are turned OFF, so that the first step-down circuit unit B1 is in the dead-time period (DT). At this time, the switch elements S22 and S23 are ON in the second step-down circuit unit B2, so that the state (CH) of accumulating the reference voltage of the reference power source Vci can be secured therein. The switch elements S31 and S34 are ON in the third step-down circuit unit B3, so that the state (DN) of supplying the accumulated electric charge to the capacity element C0 can be secured therein.

In the period in FIG. 26, which corresponds to the state shown in FIG. 36, all of the four switch elements S31, S32, S33, and S34 in the third step-down circuit unit B3 are turned OFF, so that the third step-down circuit unit B3 is in the dead-time period (DT). At this time, the switch elements S22 and S23 are ON in the second step-down circuit unit B2, so that the state (CH) for accumulating the reference voltage of the reference power source Vci can be secured therein. The switch elements S11 and S14 are ON in the first step-down circuit unit B1, so that the state (DN) for supplying the accumulated electric charge to the capacity element C0 can be secured therein.

In the period in FIG. 26, which corresponds to the state shown in FIG. 36, all of the four switch elements S21, S22, S23, and S24 in the second step-down circuit unit B2 are turned OFF, so that the second step-down circuit unit B2 is in the dead-time period (DT). At this time, the switch elements S32 and S33 are ON in the third step-down circuit unit B3, so that the state (CH) of accumulating the reference voltage of the reference power source Vci can be secured therein. The switch elements S11 and S14 are ON in the first step-down circuit unit B1, so that the state (DN) of supplying the accumulated electric charge to the capacity element C0 can be secured therein.

In the period in FIG. 26, which corresponds to the state shown in FIG. 38, all of the four switch elements S11, S12, S13, and S14 in the first step-down circuit unit B1 are turned OFF, so that the first step-down circuit unit B1 is in the dead-time period (DT). At this time, the switch elements S32 and S33 are ON in the third step-down circuit unit B3, so that the state (CH) of accumulating the reference voltage of the reference power source Vci can be secured therein. The switch elements S21 and S24 are ON in the second step-down circuit unit B2, so that the state (DN) of supplying the accumulated electric charge to the capacity element C0 can be secured therein.

The processes described above can be summarized as follows.
FIG. 27−[B1, B2, B3]=[CH, DN, CH]
FIG. 28−[B1, B2, B3]=[CH, DN, DT]
FIG. 29−[B1, B2, B3]=[CH, DN, DN]
FIG. 30−[B1, B2, B3]=[CH, DT, DN]
FIG. 31−[B1, B2, B3]=[CH, CH, DN]
FIG. 32−[B1, B2, B3]=[DT, CH, DN]
FIG. 33−[B1, B2, B3]=[DN, CH, DN]
FIG. 34−[B1, B2, B3]=[DN, CH, DT]
FIG. 35−[B1, B2, B3]=[DN, CH, CH]
FIG. 36−[B1, B2, B3]=[DN, DT, CH]
FIG. 37−[B1, B2, B3]=[DN, DN, CH]
FIG. 38−[B1, B2, B3]=[DT, DN, CH]

Looking at the record of the actions in the first step-down circuit unit B1, it is a cyclic action of CH→CH→CH→CH→CH→DT→DN→DN→DN→DN→DN→DT. Looking at the record of the actions in the second step-down circuit unit B2, it is a cyclic action of DN→DN→DN→DT→CH→CH→CH→CH→CH→DT→DN→DN. Looking at the record of the actions in the third step-down circuit unit B3, it is a cyclic action of CH→DT→DN→DN→DN→DN→DN→DT→CH→CH→CH→CH. The actions of the three step-down circuit units B1, B2, and B3 are the cyclic actions of the same pattern though the timings thereof are different.

When the third step-down circuit unit B3 is in the dead-time period (DT) (in the state of FIG. 28 or FIG. 34), the first step-down circuit unit B1 is in the state (DN) of supplying the accumulated electric charge to the capacity element C0 or in the state (CH) of accumulating the reference voltage of the reference power source Vci, and the first step-down circuit unit B1 is in the state (CH) of accumulating the reference voltage of the reference power source Vci or in the state (DN) of supplying the accumulated electric charge to the capacity element C0.

Further, when the second step-down circuit unit B2 is in the dead-time period (DT) (in the state of FIG. 30 or FIG. 36), the first step-down circuit unit B1 is in the state (CH) of accumulating the reference voltage of the reference power source Vci or in the state (DN) of supplying the accumulated electric charge to the capacity element C0, and the third step-down circuit unit B3 is in the state (DN) of supplying the accumulated electric charge to the capacity element C0 or in the state (CH) of accumulating the reference voltage of the reference power source Vci.

Furthermore, when the first step-down circuit unit B1 is in the dead-time period (DT) (in the state of FIG. 32 or FIG. 38), the second step-down circuit unit B2 is in the state (CH) of accumulating the reference voltage of the reference power source Vci or in the state (DN) of supplying the accumulated electric charge to the capacity element C0, and the third step-down circuit unit B3 is in the state (DN) of supplying the accumulated electric charge to the capacity element C0 or in the state (CH) of accumulating the reference voltage of the reference power source Vci.

That is, even if any of the step-down circuit units is in the dead-time period (DT), the other step-up circuit units always keep the state where a load is connected to the reference power source Vci that has no smoothing capacitance. Based on this, the [DT, no load] state in the case of the conventional technique is thereby solved, so that noise generated due to the [DT, no load] state can be suppressed. In addition, it is possible to secure at least one of the step-down circuit units to supply the electric charges to the capacity element C0. According to this, it is possible to achieve the effect of reducing ripples caused by the voltage (Vout) that is (−1)-time the reference voltage of the reference power source Vci and the effect of improving the current capacity.

In short, it is possible according to the embodiment to perform the step-down action while maintaining the state where the load is always imposed upon the reference power source Vci, thereby it enables noise reduction in the reference power source Vci. Furthermore, electric charges are always supplied to the capacity element C0 from at least one of the step-down circuit units. Thus, it is possible to obtain the effect of reducing ripples caused by the voltage (Vout) that is (−1)-time the reference voltage of the reference power source Vci and the effect of improving the current capacity.

In the step-down device of this embodiment, the electric charges are always supplied from at least one of the step-down circuit units to the output terminal that outputs the voltage (Vout) that is (−1)-time the reference voltage of the reference power source Vci. Thus, it is possible to omit the step-down voltage accumulating capacity element C0 that serves as a function to keep the voltage (Vout) that is (−1)-time the reference voltage of the reference power source Vci.

### Fourth Embodiment

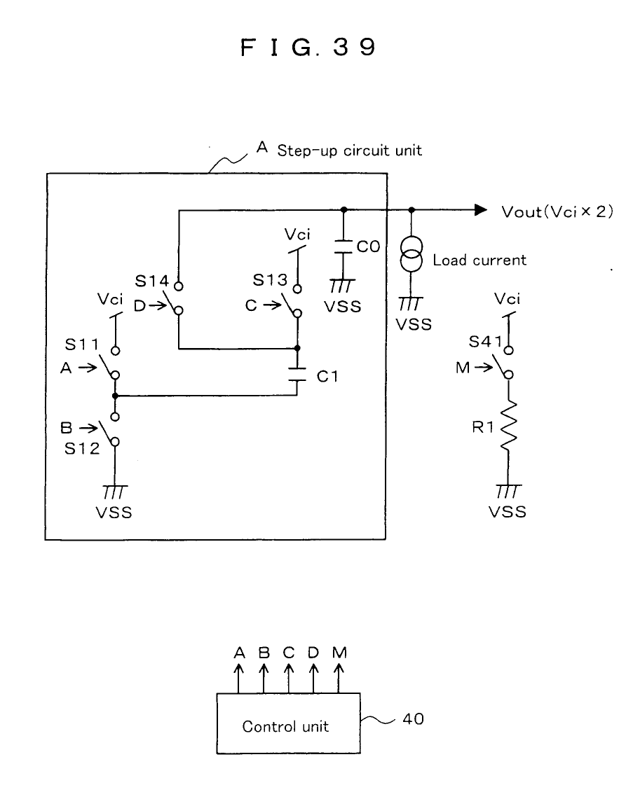

Each of the aforementioned embodiments has been described referring to the structures of the present invention, in which the noise of the reference power source Vci are reduced by connecting the two or more step-up circuit units or step-down circuit units. However, the same effects as those described above can be achieved even through adding a circuit for forcibly supplying a load to the reference power source Vci only during the dead-time period to the step-up circuit unit or the step-down circuit unit. This is achieved in a fourth embodiment of the present invention. Hereinafter, the step-up device according to the fourth embodiment will be described. FIG. 39 is a circuit block diagram showing the structure of the step-up device according to the fourth embodiment of the present invention. The step-up device of this embodiment is characterized by providing a resistance as a load current source through a switch element.

Switch elements S11 and S12 are connected in series between a reference power source Vci and a ground VSS. A switch element S13 and a reference power source voltage accumulating capacity element C1 are connected in series between the reference power source Vci and the connection point of both switch elements S11, S12. A switch element S14 and a step-up voltage accumulating capacity element C0 are connected in series between the connection point of the switch element 13 and the capacity element C0, and the ground VSS. The capacity element C0 keeps and outputs a voltage (Vout) that is twice the reference power source Vci.

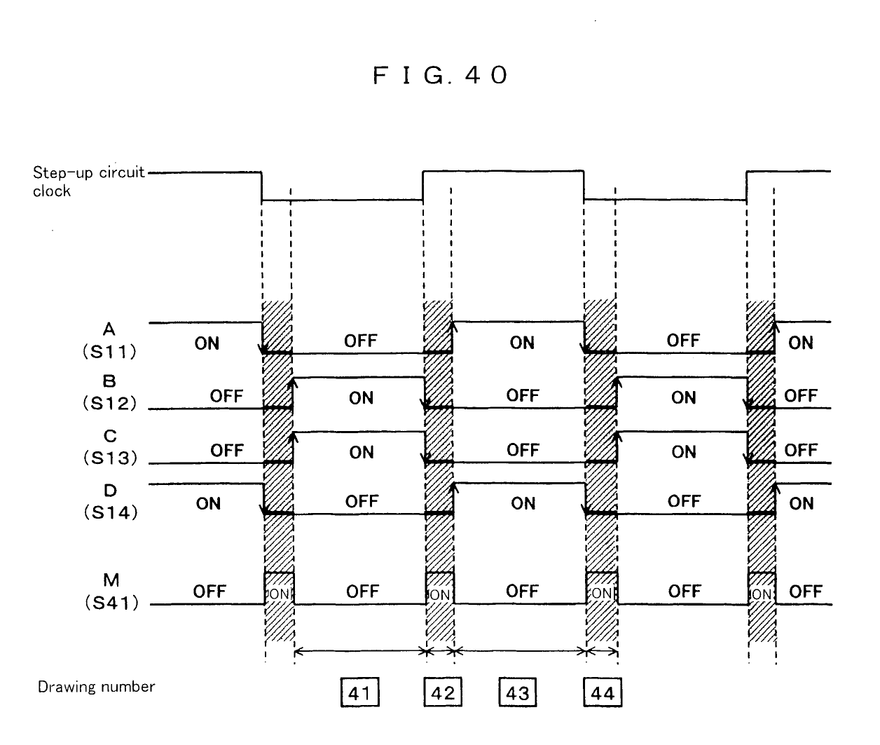

In the timing chart shown in FIG. 40, the control signals A, B, C, and D control ON/OFF of the switch elements S11, S12, S13, and S14, respectively. The switch devices S11, S12, S13, S14 and the capacity element C1 constitute a step-up circuit unit A1.

A switch element 41 and a resistance R1 are connected in series between the reference power source Vci and the ground VSS. The switch element S41 is controlled by a signal M shown in FIG. 40. In FIG. 40, hatching areas are dead-time period (DT) . Reference numeral 40 indicates a control unit. The control unit 40 generates the control signals A, B, C, D and the control signal M.

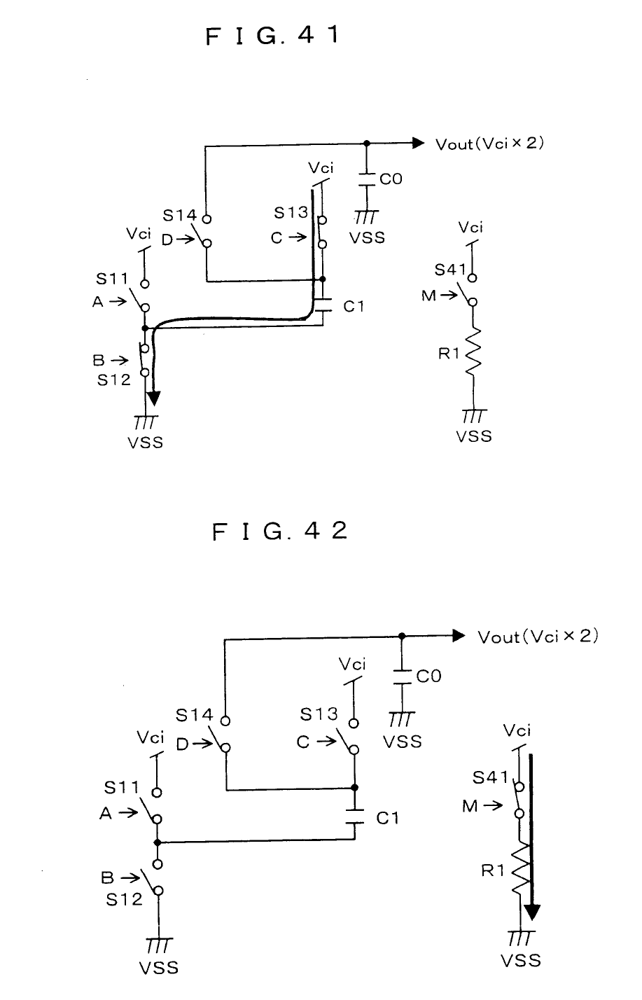

Next, the actions of the step-up device according to this embodiment, which is constituted in the above-described manner, will be described referring to FIG. 41-FIG. 44. First, as shown in FIG. 41, the switch elements S12, S13 are turned ON, while the switch elements S11, S14 and the switch element S41 are turned OFF. During this period, the capacity element C1 is in the state (CH) of accumulating the reference voltage of the reference power source Vci, and there is no electric current flown to the resistance R1. In this period, no load is imposed upon the reference power source from the step-up circuit unit A.

Next, as shown in FIG. 42, the switch elements S12, S13 in the step-up circuit unit A1 are turned OFF and the switch element S41 is turned ON from the state shown in FIG. 41. Although it is in the dead-time period (DT) of the step-up circuit unit A1, it becomes a state where a load is imposed upon the reference power source Vci through the resistance R1 during this period.

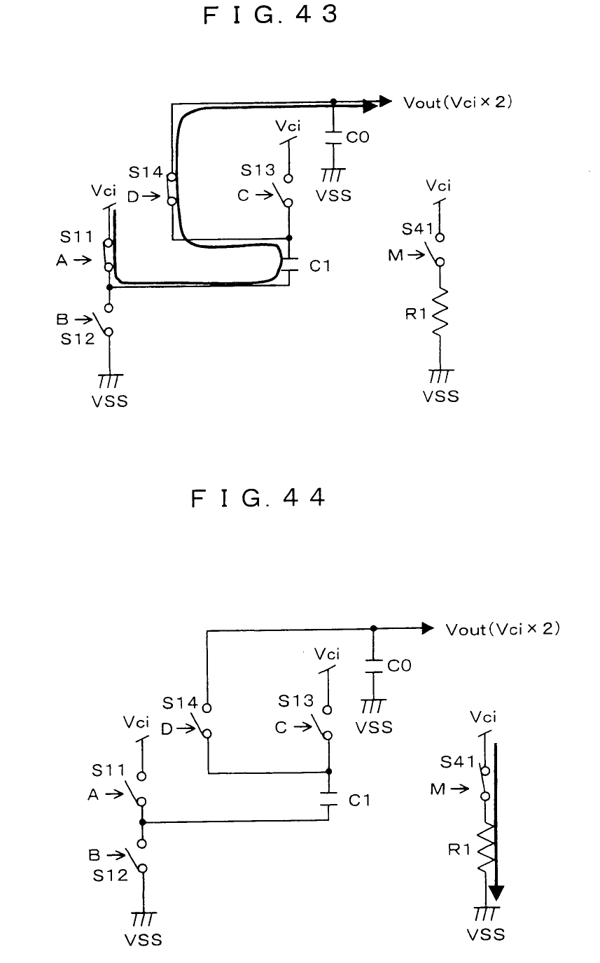

Next, as shown in FIG. 43, the switch elements S12, S13 are turned ON and the switch element S41 is turned OFF from the state shown in FIG. 42. During this period, the capacity element C1 and the capacity element C0 are connected. Thus, it is in the state (UP) of supplying the electric charges accumulated in the capacity element C1 to the capacity element C0, and there is no electric current flown to the resistance R1. During this period, the step-up circuit unit A is connected to the reference power source Vci as the load.

Next, as shown in FIG. 44, the switch elements S12, S13 are turned OFF and the switch element S41 is turned ON from the state shown in FIG. 43. Although it is in the dead-time period (DT) of the step-up circuit unit A in the period, it becomes a state where a load is imposed upon the reference power source Vci through the resistance R1.

Through repeating the actions shown in FIG. 41-FIG. 44, the voltage (Vout) that is twice the reference power source Vci is generated in the capacity element C0.

It is possible according to the embodiment to perform boost-up action while maintaining the state where the load is always imposed upon the reference power source Vci, thereby it enables noise reduction in the reference power source Vci. MOS transistors and bipolar transistors are known as the switch elements described in the aforementioned embodiments. However, it should not be limited to those types but any kinds of devices may be used as long as those devices have the switching functions.

### Fifth Embodiment

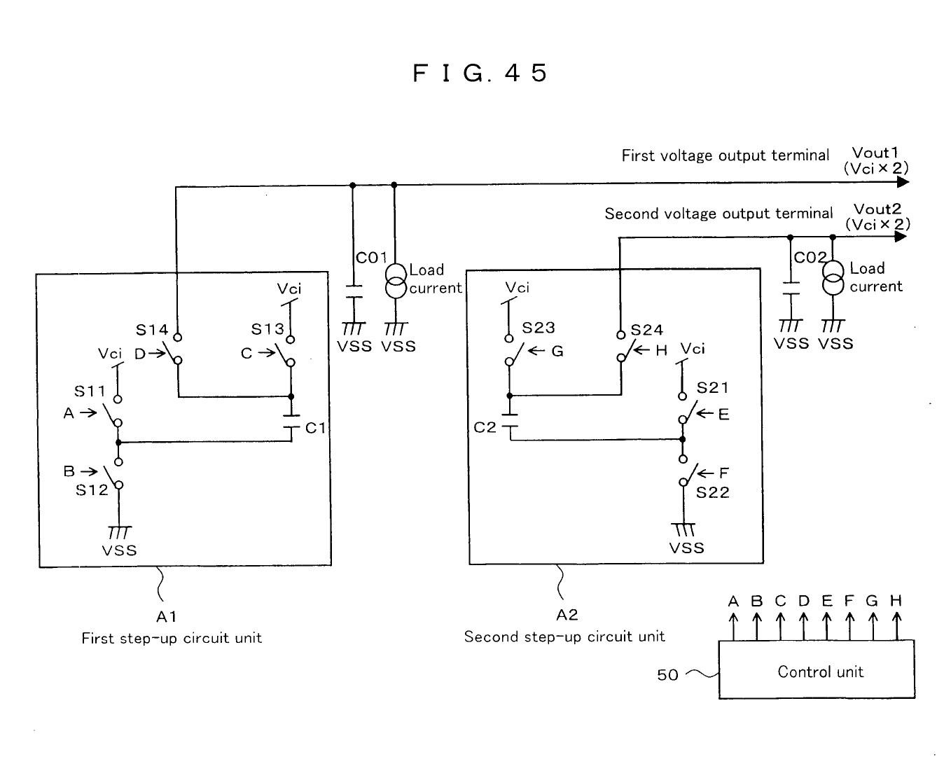

FIG. 45 is a circuit block diagram showing the structure of a step-up device according to a fifth embodiment of the present invention. In the step-up device of this embodiment, a first step-up voltage accumulating capacity element C01 is connected to a first voltage output terminal Vout1, and a first step-up circuit unit A1 is connected to the capacity element C01. A second step-up voltage accumulating capacity element C02 is connected to a second voltage output terminal Vout2, and a second step-up circuit unit A2 is connected to the capacity element C02. The capacity element C01 keeps and outputs the voltage (Vout1) that is twice the reference power source Vci. The capacity element C02 keeps and outputs the voltage (Vout2) that is twice the reference power source Vci.

In the first step-up circuit unit A1, switch elements S11 and S12 are connected in series between a reference power source Vci and a ground VSS. A switch element S13 and a reference power source voltage accumulating capacity element C1 are connected in series between the reference power source Vci and the connection point of both switch elements S11, S12. A switch element S14 and the capacity element C01 are connected in series between the connection point of the switch element 13 and the capacity element C1, and the ground VSS. The switch elements S11, S12, S13, S14 and the capacity element C1 constitute the first step-up circuit unit A1.

In the second step-up circuit unit A2, switch elements S21 and S22 are connected in series between a reference power source Vci and a ground VSS. A switch element S23 and a reference power source voltage accumulating capacity element C2 are connected in series between the connection point of both switch elements S21, S22 and the reference power source Vci. A switch element S24 and the capacity element C02 are connected in series between the connection point of the switch element 23 and the capacity element C2, and the ground VSS. The switch elements S21, S22, S23, S24 and the capacity element C2 constitute the second step-up circuit unit A2.

One end of the capacity element C01 is connected to the ground VSS, and the other end thereof is connected to the switch element S14. As a result, the voltage (Vout1) that is twice the reference power source Vci is outputted to this section (connection point between the other end of the capacity element C01 and the switch elements S14). One end of the capacity element C02 is connected to the ground VSS, and the other end thereof is connected to the switch element S24. As a result, the voltage (Vout2) that is twice the reference power source Vci is outputted to this section (connection point between the other end of the capacity element C02 and the switch elements S24).

Reference numeral 50 is a control unit. The control unit 50 generates control signals A, B, C, D for controlling ON/OFF of the switch elements S11, S12, S13, S14 in the first step-up circuit unit A1, and control signals E, F, G, H for controlling the switch elements S21, S22, S23, S24 in the second step-up circuit unit A2. The control unit 50 performs a control to carry out an electric charge accumulation action or pumping action in one of the first or second step-up circuit A1 or A2, when the other step-up circuit is in a dead-time period. This control is carried out alternately and cyclically between both step-up circuits A1 and A2. Each of the switch elements is constituted with a transistor or the like. The reference power source Vci is a power source having no smoothing capacitance.

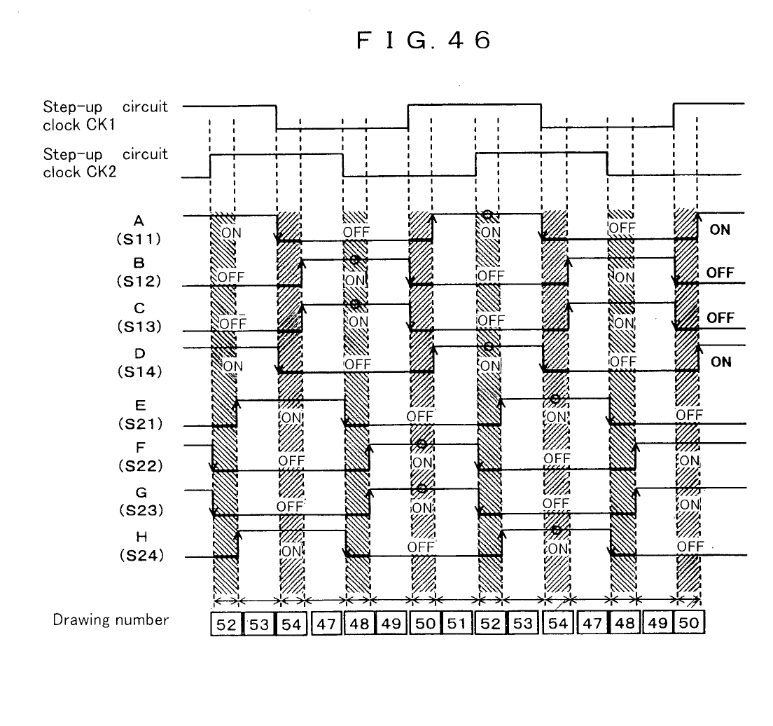

FIG. 46 is a timing chart showing the action of the step-up device according to this embodiment. In FIG. 46, the control signals A, B, C, and D are generated based on the first clock CK1 for the step-up circuit. The control signals E, F, G, and H are generated based on the second clock CK2 for the step-up circuit. In FIG. 46, hatching areas are dead-time periods (DT).

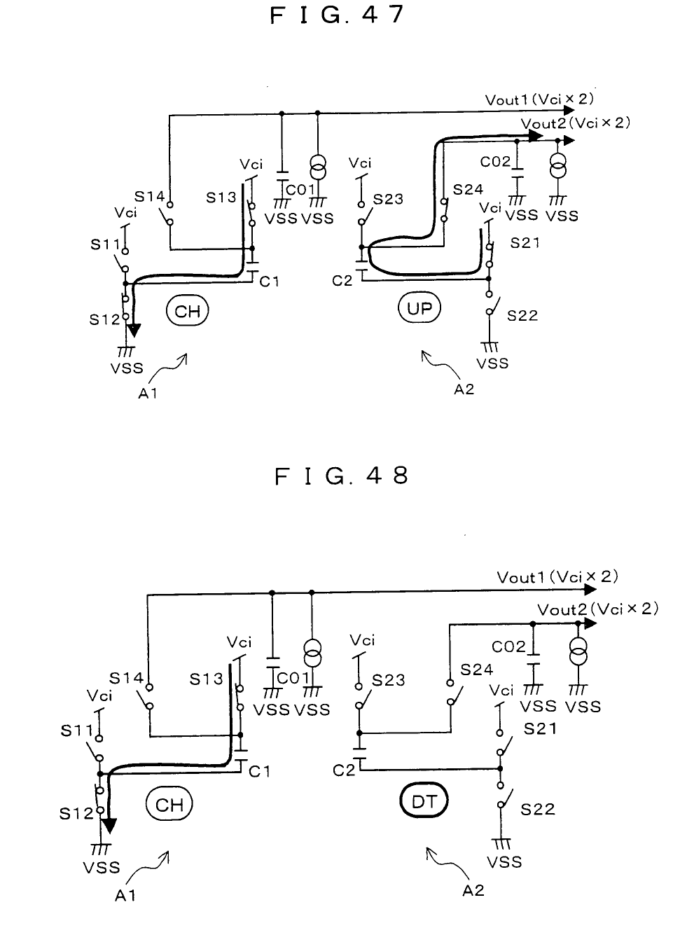

Next, the actions of the step-up device according to this embodiment, which is constituted in the above-described manner, will be described referring to FIG. 47-FIG. 54. First, as shown in FIG. 47, the switch elements S12, S13 of the first step-up circuit unit A1 and the switch elements S21, S24 of the second step-up circuit unit A2 are turned ON, while the switch elements S11, S14 and the switch elements S22, S23 are turned OFF. During this period, the capacity element C1 of the first step-up circuit unit A1 is in the state (CH) of accumulating the reference voltage of the reference power source Vci, and the capacity element C2 of the second step-up circuit unit A2 is in the state (UP) of supplying the accumulated electric charge to the capacity element C02 by a pumping action. During this period, loads at two sections are connected to the reference power source Vci. This state in this period is expressed as [A1, A2]=[CH, UP].

Next, as shown in FIG. 48, the switch elements S21 and S24 in the second step-up circuit unit A2 are turned OFF from the state shown in FIG. 47. In this period, the capacity element C1 in the first step-up circuit unit A1 is in the state (CH) of accumulating the reference voltage of the reference power source Vci, and the second step-up circuit unit A2 is in the dead-time period (DT). The first step-up circuit unit A1 remains in the operating state in this period, so that the load at one section is connected to the reference power source Vci. The state in this period is expressed as [A1, A2]=[CH, DT].

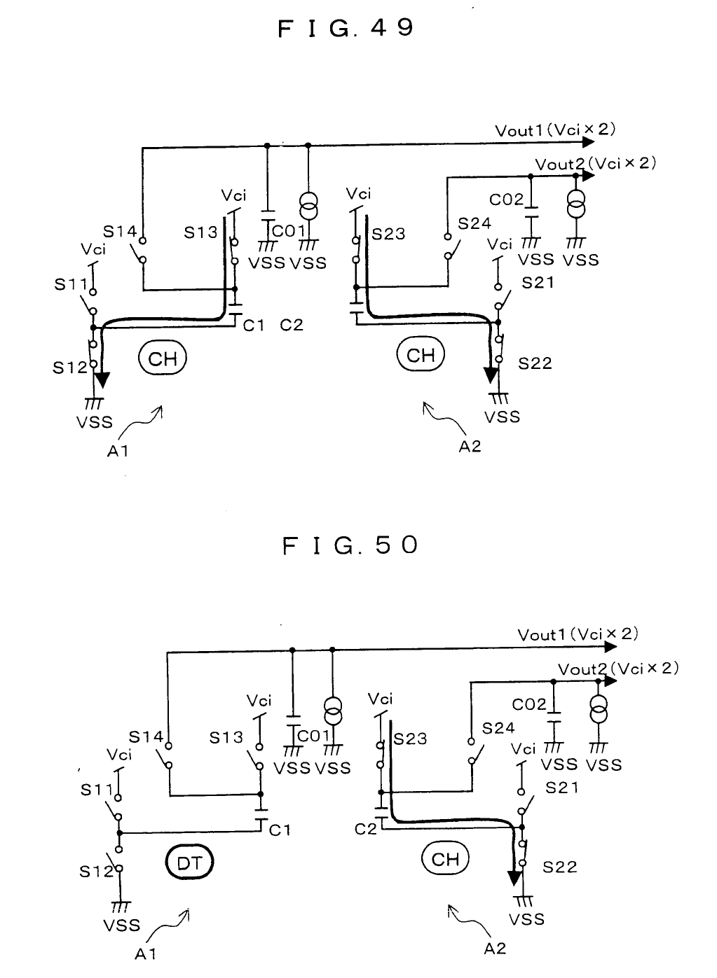

Next, as shown in FIG. 49, the switch elements S22 and S23 in the second step-up circuit unit A2 are turned ON from the state shown in FIG. 48. In this period, the capacity element C1 in the first step-up circuit unit A1 is in the state (CH) of accumulating the reference voltage of the reference power source Vci, and the capacity element C2 in the second step-up circuit unit A1 is in the state (CH) of accumulating the reference voltage of the reference power source Vci as well. In this period, the loads at two sections are connected to the reference power source Vci. The state in this period is expressed as [A1, A2]=[CH, CH].

Next, as shown in FIG. 50, the switch elements S12 and S13 in the first step-up circuit unit A1 are turned OFF from the state shown in FIG. 49. In this period, the capacity element C2 in the second step-up circuit unit A2 is in the state (CH) of accumulating the reference voltage of the reference power source Vci, and the first step-up circuit unit A1 is in the dead-time period (DT) The second step-up circuit unit A2 remains in the operating state in this period, so that the load at one section is connected to the reference power source Vci. The state in this period is expressed as [A1, A2]=[DT, CH].

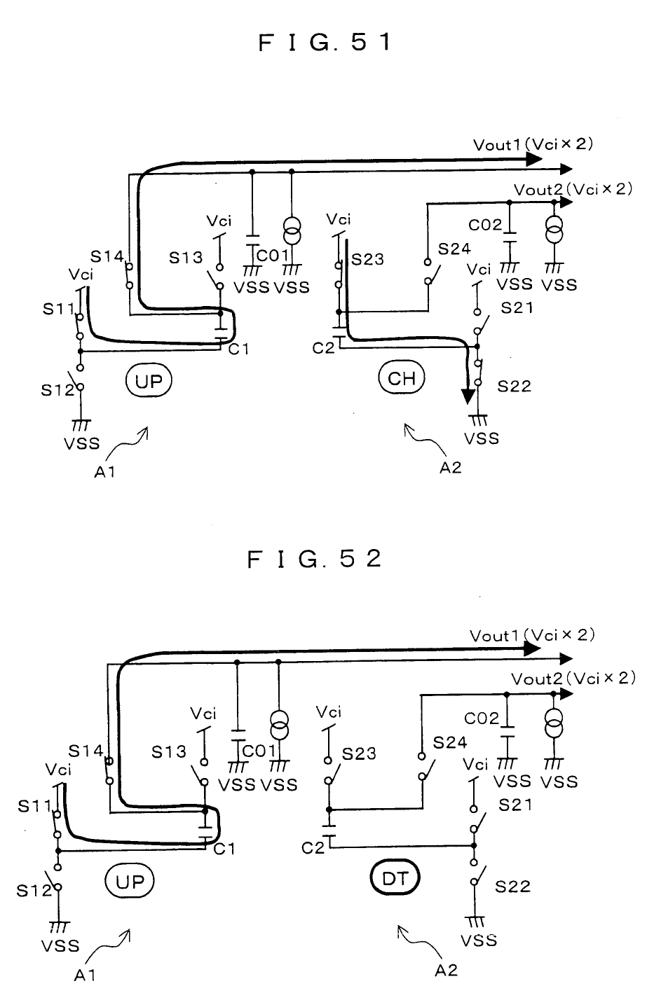

Next, as shown in FIG. 51, the switch elements S11 and S14 in the first step-up circuit unit A1 are turned ON from the state shown in FIG. 50 so as to apply the reference voltage of the reference power source Vci to the capacity element C1 in the inverse direction. During this period, the capacity element C2 of the second step-up circuit unit A2 is in the state (CH) of accumulating the reference voltage of the reference power source Vci, and the capacity element C1 of the first step-up circuit unit A1 is in the state (UP) of supplying the accumulated electric charge to the capacity element C01 by a pumping action. During this period, the loads at two sections are connected to the reference power source Vci. This state in this period is expressed as [A1, A2]=[UP, CH].

Next, as shown in FIG. 52, the switch elements S22 and S23 in the second step-up circuit unit A2 are turned OFF from the state shown in FIG. 51. In this period, the capacity element C1 of the first step-up circuit unit A1 is in the state (UP) of supplying the accumulated electric charge to the capacity element C0 by a pumping action, and the second step-up circuit unit A2 is in the dead-time period (DT). The first step-up circuit unit A1 remains in the operating state in this period, so that the load at one section is connected to the reference power source Vci. The state in this period is expressed as [A1, A2]=[UP, DT].

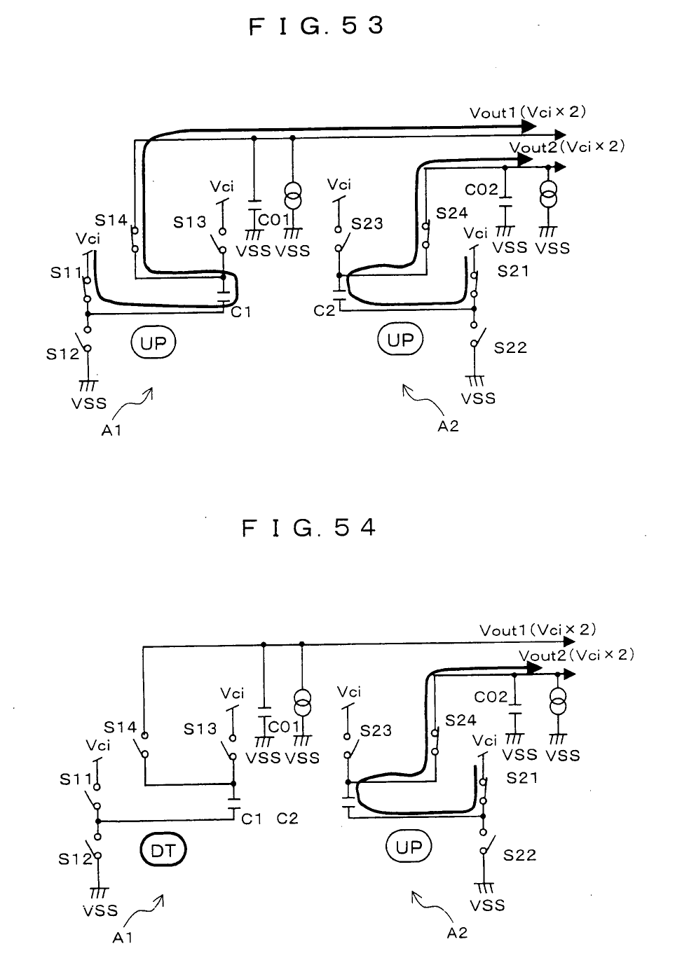

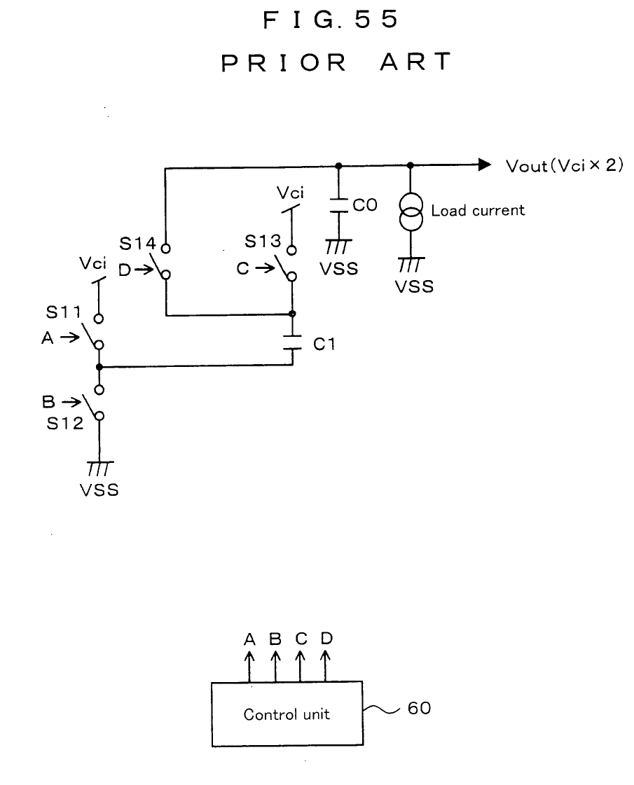

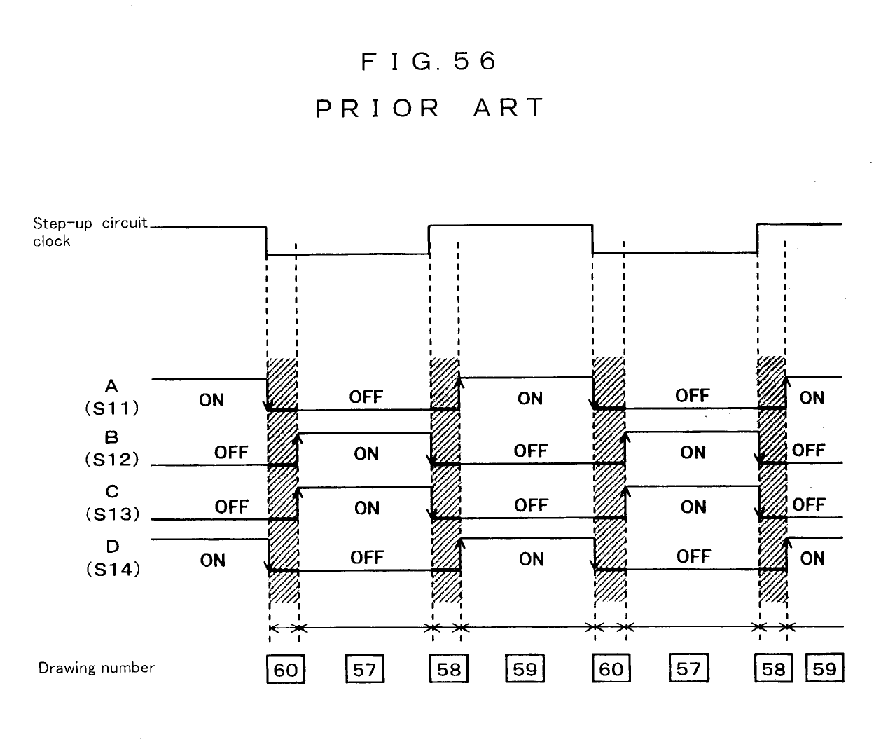

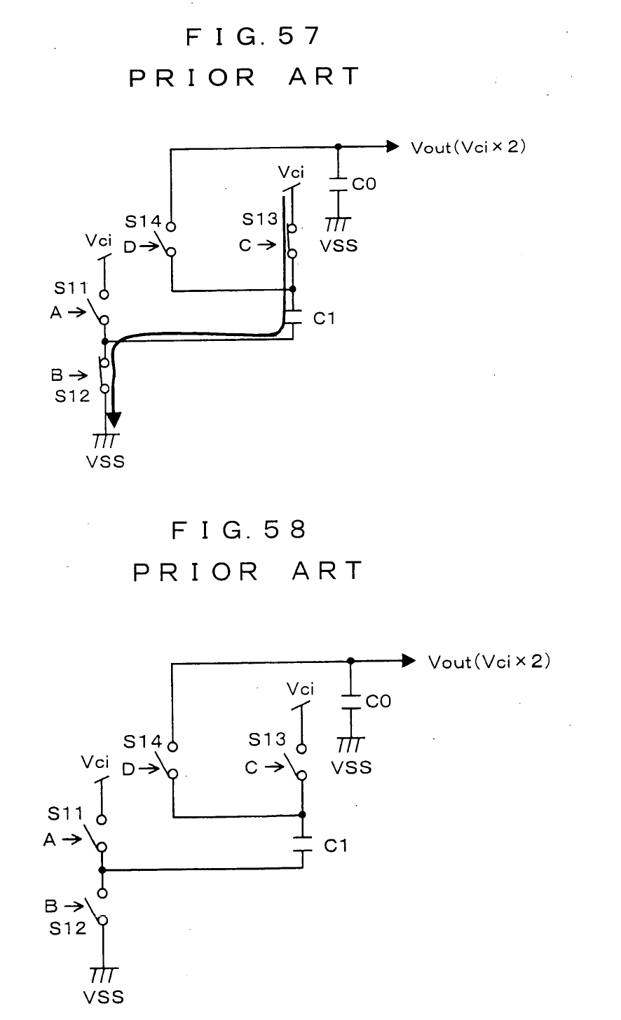

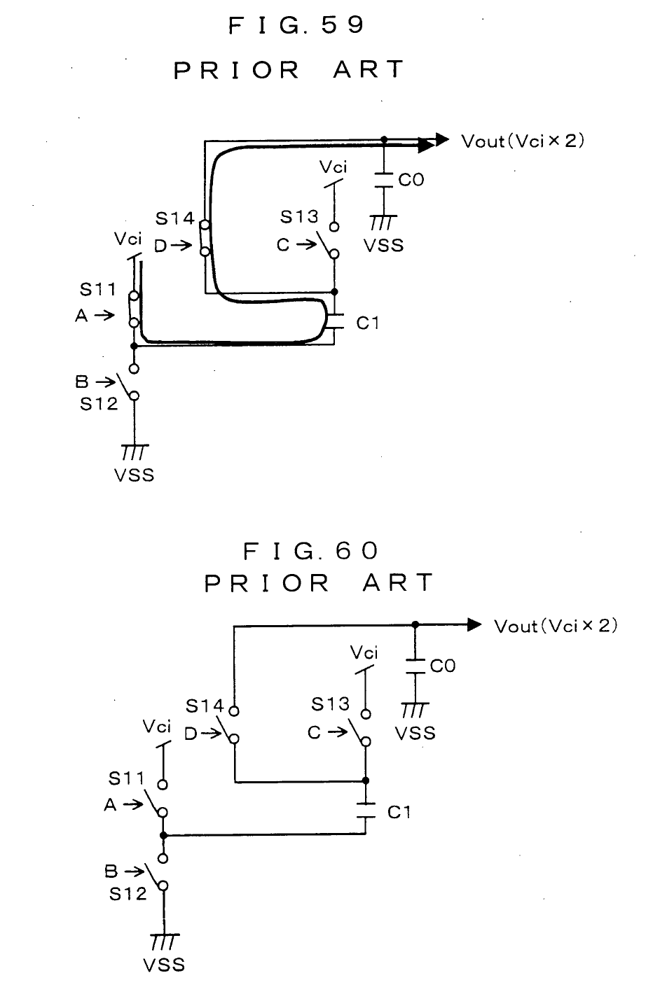

Next, as shown in FIG. 53, the switch elements S21 and S24 in the second step-up circuit unit A2 are turned ON from the state shown in FIG. 52 so as to apply the reference voltage of the reference power source Vci to the capacity element C2 in the inverse direction. During this period, the capacity element C1 of the first step-up circuit unit A1 is in the state (UP) of supplying the accumulated electric charge to the capacity element C01 by a pumping action, and the capacity element C2 of the second step-up circuit unit A2 is in the state (UP) of supplying the accumulated electric charge to the capacity element C02 by a pumping action. During this period, the loads at two sections are connected to the reference power source Vci. This state in this period is expressed as [A1, A2]=[UP, UP].

Next, as shown in FIG. 54, the switch elements S11 and S14 in the first step-up circuit unit A1 are turned OFF from the state shown in FIG. 53. In this period, the capacity element C2 of the second step-up circuit unit A2 is in the state (UP) of supplying the accumulated electric charge to the capacity element C02 by a pumping action, and the first step-up circuit unit A1 is in the dead-time period (DT). The second step-up circuit unit A2 remains in the operating state in this period, so that the load at one section is connected to the reference power source Vci. The state in this period is expressed as [A1, A2]=[DT, UP].

Through repeating the actions shown in FIG. 47-FIG. 54, the voltage (Vout1) that is twice the reference power source Vci is generated in the capacity element C01, and the voltage (Vout2) that is twice the reference power source Vci is generated in the capacity element C02.

In the period in FIG. 46, which corresponds to the state shown in FIG. 48, all of the four switch elements S21, S22, S23, and S24 in the second step-up circuit unit A2 are turned OFF, so that the second step-up circuit unit A2 is in the dead-time period (DT). At this time, the switch elements S12 and S13 are ON in the first step-up circuit unit A1, so that the state (CH) of accumulating the reference voltage of the reference power source Vci can be secured therein.

Further, in the period in FIG. 46, which corresponds to the state shown in FIG. 50, all of the four switch elements S11, S12, S13, and S14 in the first step-up circuit unit A1 are turned OFF, so that the first step-up circuit unit A1 is in the dead-time period (DT). At this time, the switch elements S22 and S23 are ON in the second step-up circuit unit A2, so that the state (CH) of accumulating the reference voltage of the reference power source Vci can be secured therein.

Furthermore, in the period in FIG. 46, which corresponds to the state shown in FIG. 52, all of the four switch elements S21, S22, S23, and S24 in the second step-up circuit unit A2 are turned OFF, so that the second step-up circuit unit A2 is in the dead-time period (DT). At this time, the switch elements S11 and S14 are ON in the first step-up circuit unit A1, so that the state (UP) of supplying the accumulated electric charge to the capacity element C01 can be secured therein.

Moreover, in the period in FIG. 46, which corresponds to the state shown in FIG. 54, all of the four switch elements S11, S12, S13, and S14 in the first step-up circuit unit A1 are turned OFF, so that the first step-up circuit unit A1 is in the dead-time period (DT). At this time, the switch elements S21 and S24 are ON in the second step-up circuit unit A2, so that the state (UP) of supplying the accumulated electric charge to the capacity element C02 can be secured therein.

The processes described above can be summarized as follows.
FIG. 47−[A1, A2]=[CH, UP]
FIG. 48−[A1, A2]=[CH, DT]
FIG. 49−[A1, A2]=[CH, CH]
FIG. 50−[A1, A2]=[DT, CH]
FIG. 51−[A1, A2]=[UP, CH]
FIG. 52−[A1, A2]=[UP, DT]
FIG. 53−[A1, A2]=[UP, UP]
FIG. 54−[A1, A2]=[DT, UP]

Looking at the record of the actions in the first step-up circuit unit A1, it is a cyclic action of CH→CH→CH→DT→UP→UP→UP→DT. Looking at the record of the actions in the second step-up circuit A2, it is a cyclic action of UP→DT→CH→CH→CH→DT→UP→UP. The actions of both step-up circuit units A1 and A2 are the cyclic actions with the same pattern though the timings thereof are different.

When the second step-up circuit unit A2 is in the dead-time period (DT) (in the state of FIG. 48 or FIG. 52), the first step-up circuit unit A1 is in the state (CH) of accumulating the reference voltage of the reference power source Vci or in the state (UP) of supplying the accumulated electric charge to the capacity element C01 by a pumping action.

Further, when the first step-up circuit unit A1 is in the dead-time period (DT) (in the state of FIG. 50 or FIG. 54), the second step-up circuit unit A2 is in the state (CH) of accumulating the reference voltage of the reference power source Vci or in the state (UP) of supplying the accumulated electric charge to the capacity element C02 by a pumping action.

In short, the following rules are maintained.

[A1, A2]=[with load, DT]

[A1, A2]=[DT, with load]

That is, even if one of the step-up circuit units is in the dead-time period (DT), the other step-up circuit unit always keeps the state where a load is connected to the reference power source Vci that has no smoothing capacitance. The [DT, no load] state in the case of the conventional technique is thereby solved, so that noise generated due to the [DT, no load] state can be suppressed.

In short, it is possible according to the embodiment to perform the boost-up action while maintaining the state where the load is always imposed upon the reference power source Vci, thereby it enables noise reduction in the reference power source Vci.

The present invention has been described in detail referring to the most preferred embodiments. However, various combinations and modifications of the components are possible without departing from the spirit and the broad scope of the appended claims.

What is claimed is:

1. A step-up device, comprising
a voltage output terminal,
a step-up voltage accumulating capacity element connected to said voltage output terminal,
a first step-up circuit unit and a second step-up circuit unit connected in parallel to said step-up voltage accumulating capacity element, and
a control unit, wherein:
said first step-up circuit unit and said second step-up circuit unit comprise, respectively,
a reference power source for generating a reference power source voltage,
a reference power source voltage accumulating capacity element, and
a group of switch elements capable of freely connecting/disconnecting said reference power source and said reference power source voltage accumulating capacity element;
said control unit controls said group of switch elements so that a step-up voltage is supplied to said voltage output terminal by a pumping action carried out in said step-up voltage accumulating capacity element so that said reference power source voltage is applied to said reference power source voltage accumulating capacity element in an inverse direction, after execution of an electric charge accumulating action with said reference power source voltage in said reference power source voltage accumulating capacity element;
said control unit further controls said group of switching elements to provide a dead-time period, during which said reference power source and said reference power source voltage accumulating element are disconnected, between a period of said electric charge accumulating action and a period of said pumping action and between said period of said pumping action and said period of said electric charge accumulating action; and
said control unit furthermore performs such a control in said first and second step-up circuit units alternately and cyclically that said period of said electric charge accumulating action or said period of said pumping action is carried out in one of said first and second step-up circuit units, when the other is in said dead-time period.

2. The step-up device according to claim 1, wherein said reference power source does not have a smoothing capacitor.

3. A step-up device, comprising
a voltage output terminal,
three or more step-up circuit units connected in parallel to said voltage output terminal, and
a control unit, wherein:
said step-up circuit units comprise, respectively,
a reference power source for generating a reference power source voltage,
a reference power source voltage accumulating capacity element, and
a group of switch elements capable of freely connecting/disconnecting said reference power source and said reference power source voltage accumulating capacity element;
said control unit controls said group of switch elements so that a step-up voltage is supplied to said voltage output terminal by a pumping action carried out in said step-up voltage accumulating capacity element so that said reference power source voltage is applied to said reference power source voltage accumulating capacity element in an inverse direction, after execution of an electric charge accumulating action with said reference power source voltage in said reference power source voltage accumulating capacity element;
said control unit further controls said group of switching elements to provide a dead-time period, during which said reference power source and said reference power source voltage accumulating element are disconnected, between a period of said electric charge accumulating action and a period of said pumping action and between said period of said pumping action and said period of said electric charge accumulating action; and
said control unit furthermore performs such a control in said three or more step-up circuit units alternately and cyclically that said electric charge accumulating action or said pumping action is carried out in other units, when one of said three or more step-up circuit units is in said dead-time period.

4. The step-up device according to claim 3, wherein said reference power source does not have a smoothing capacitor.

5. A step-up device, comprising
a voltage output terminal,
a step-up voltage accumulating capacity element connected to said voltage output terminal,
a step-up circuit unit connected to said step-up voltage accumulating capacity element, and
a control unit, wherein:
said step-up circuit unit comprises
a reference power source for generating a reference power source voltage,
a reference power source voltage accumulating capacity element,
a load current source,
a first group of switch elements capable of freely connecting/disconnecting said reference power source and said reference power source voltage accumulating capacity element, and
a second switch element capable of freely connecting/disconnecting said reference power source and said load current source;
said control unit controls said first group of switch elements so that a step-up voltage is supplied to said voltage output terminal by a pumping action carried out in said step-up voltage accumulating capacity element so that said reference power source voltage is applied to said reference power source voltage accumulating capacity element in an inverse direction, after execution of an electric charge accumulating action with said reference power source voltage in said reference power source voltage accumulating capacity element;
said control unit further controls said first group of switching elements so as to provide a dead-time period, during which said reference power source and said reference power source voltage accumulating element are disconnected, between a period of said electric charge accumulating action and a period of said pumping action and between said period of said pumping action and said period of said electric charge accumulating action; and
said control unit furthermore controls said second switch element so that said reference power source and said load current source are selectively conductive in said dead-time period.

6. The step-up device according to claim 5, wherein said reference power source does not have a smoothing capacitor.

7. A step-down device, comprising
a voltage output terminal,
three or more step-down circuit units connected in parallel to said voltage output terminal, and
a control unit, wherein:
said step-down circuit units comprise, respectively,
a reference power source for generating a reference power source voltage,
a reference power source voltage accumulating capacity element, and
a group of switch elements capable of freely connecting/disconnecting said reference power source and said reference power source voltage accumulating capacity element;
said control unit controls said group of switch elements so that a step-down voltage is supplied to said voltage output terminal by a pumping action carried out in said reference power source voltage accumulating capacity element so that said reference power source voltage is applied to said reference power source voltage accumulating capacity element in a same direction, after execution of an electric charge accumulating action with said reference power source voltage in said reference power source voltage accumulating capacity element;
said control unit further controls said group of switching elements so as to provide a dead-time period, during which said reference power source and said reference power source voltage accumulating element are disconnected, between a period of said electric charge accumulating action and a period of said pumping action and between said period of said pumping action and said period of said electric charge accumulating action; and
said control unit furthermore performs such a control in said three or more step-down circuit units alternately and cyclically that said electric charge accumulating action or said pumping action is carried out in other units, when one of said three or more step-down circuit units is in said dead-time period.

8. The step-down device according to claim 7, wherein said reference power source does not have a smoothing capacitor.

9. A step-up device, comprising
a first voltage output terminal,
a second voltage output terminal,
a first step-up voltage accumulating capacity element connected to said first voltage output terminal,
a first step-up circuit unit connected to said first step-up voltage accumulating capacity element,
a second step-up voltage accumulating capacity element connected to said second voltage output terminal,
a second step-up circuit unit connected to said second step-up voltage accumulating capacity element, and
a control unit, wherein:
said first step-up circuit unit and said second step-up circuit unit comprise, respectively,
a reference power source for generating a reference power source voltage,
a reference power source voltage accumulating capacity element, and
a group of switch elements capable of freely connecting/disconnecting said reference power source and said reference power source voltage accumulating capacity element;
said control unit controls said group of switch elements so that a step-up voltage is supplied to said first voltage output terminal and said second voltage output terminal by pumping actions carried out in said first step-up voltage accumulating capacity element and said second step-up voltage accumulating capacity element by applying said reference power source voltage to said reference power source voltage accumulating capacity element in an inverse direction, after execution of an electric charge accumulating action based on said reference power source voltage in said reference power source voltage accumulating capacity element;
said control unit further controls said group of switching elements so as to provide a dead-time period, during which said reference power source and said reference power source voltage accumulating element are disconnected, between a period of said electric charge accumulating action and a period of said pumping action and between said period of said pumping action and said period of said electric charge accumulating action; and
said control unit furthermore performs such a control in said first and second step-up circuit units alternately and cyclically that said electric charge accumulating action or said pumping action is carried out in one of said first and second step-up circuit units, when the other is in said dead-time period.

10. The step-up device according to claim 9, wherein said reference power source does not have a smoothing capacitor.
